(19) United States
(12) Patent Application Publication
(10) Pub. No.: US 2026/0197847 A1
(43) Pub. Date: Jul. 9, 2026

(54) METHOD FOR SIDELINK TRANSMISSION AND RECEPTION IN WIRELESS COMMUNICATION SYSTEM, AND DEVICE THEREFOR

(71) Applicant: DONGGUK UNIVERSITY INDUSTRY-ACADEMIC COOPERATION FOUNDATION, Seoul (KR)

(72) Inventors: Seunghoon HWANG, Seoul (KR); Jicheng YIN, Seoul (KR)

(21) Appl. No.: 19/132,349

(22) PCT Filed: Nov. 21, 2023
(86) PCT No.: PCT/KR2023/018832

§ 371 Date: May 22, 2025

(30) Foreign Application Priority Data
Nov. 22, 2022 (KR) 10-2022-0157723

(51) Int. Cl. H04W 72/25; H04W 92/18

(52) U.S. Cl. CPC H04W 72/25; H04W 92/18

(57) ABSTRACT

A method by which a terminal performs sidelink transmission in a wireless communication system comprises the steps of: receiving configuration information related to the configuration of a resource pool containing resources for transmitting sidelink information, wherein the resource pool is configured separately into at least two resource pool parts that are differentiated on the basis of the type of information to be transmitted; selecting a resource for transmitting the sidelink information from the resource pool configured on the basis of the configuration information, wherein the selected resource for transmitting the sidelink information is a resource included in a specific resource pool part related to the type of the sidelink information from among the at least two resource pool parts; and transmitting the sidelink information on the selected resource.

### TECHNICAL FIELD

The present disclosure relates to wireless communication systems, and more particularly to methods and apparatus for performing sidelink transmission/reception.

### BACKGROUND ART

Since the commercialization of fourth generation (4G) communication systems, efforts have been made to develop improved fifth generation (5G) communication systems or pre-5G communication systems to meet the growing demand for wireless data traffic. For this reason, 5G communication systems or pre-5G communication systems are often referred to as Beyond 4G Network (Beyond 4G Network) communication systems or Post LTE (Long-Term Evolution) systems. To achieve high data rates, 5G communication systems are being considered for implementation in ultra-high frequency (mmWave) bands (e.g., the 60 Giga (70 GHz) band). To mitigate the path loss of radio waves in the ultra-high frequency band and increase the transmission distance of radio waves, beamforming, massive MIMO, full dimensional MIMO (FD-MIMO), array antenna, analog beam-forming, and large scale antenna techniques are being discussed for 5G communication systems. In addition, to improve the system's network, 5G communication systems are developing technologies such as advanced small cell, enhanced small cell, cloud radio access network (cloud RAN), ultra-dense network, device to device communication (D2D), wireless backhaul, moving network, cooperative communication, coordinated multi-points (COMP), and interference cancellation. In addition, advanced coding modulation (ACM) schemes such as FQAM (Hybrid FSK and QAM Modulation) and SWSC (Sliding Window Superposition Coding) are being developed for 5G systems, as well as advanced access technologies such as FBMC (Filter Bank Multi Carrier), NOMA (non-orthogonal multiple access), and SCMA (sparse code multiple access).

Sidelink (SL) refers to a communication method that establishes a direct link between user equipment (UE)/terminal, bypassing the base station (BS) and directly exchanging voice or data between UEs. SL is being considered as a way to solve the burden on base stations due to rapidly increasing data traffic.

Vehicle-to-everything (V2X) refers to a communication technology that exchanges information with other vehicles, pedestrians, infrastructure, etc. through wired and wireless communication. V2X can be categorized into four types: vehicle-to-vehicle (V2V), vehicle-to-infrastructure (V2I), vehicle-to-network (V2N), and vehicle-to-pedestrian (V2P). V2X communication can be provided via PC5 interface and/or Uu interface.

Meanwhile, as more and more communication devices require greater communication capacity, there is a need for improved mobile broadband communication compared to conventional Radio Access Technology (RAT). Accordingly, communication systems that consider reliability and latency-sensitive services or terminals are being discussed, and next-generation radio access technologies that consider improved mobile broadband communication, massive machine type communication (MTC), ultra-reliable and low latency communication (URLLC), etc. can be referred to as new radio access technology (new RAT) or new radio (NR). NR may also support vehicle-to-everything (V2X) communications.

### DISCLOSURE

### Technical Problem

The present disclosure provides methods and apparatus for transmitting sidelink information in a wireless communication system.

The disclosure also provides methods and apparatus for establishing resource pools that are categorized based on message information.

The technical problems to be solved by the present disclosure are not limited to the technical problems mentioned above, and other technical problems not mentioned will become apparent to those having ordinary knowledge in the technical field to which the present disclosure belongs from the following description.

### Technical Solution

The present disclosure proposes a method for a terminal to transmit sidelink information in a wireless communication system.

More specifically, in the present disclosure, a method of a terminal for transmitting sidelink information in a wireless communication system, receiving configuration information associated with configuration of a resource pool including resources for transmitting the sidelink information, wherein the resource pool is configured to be separated into at least two resource pool portions distinguished based on a type of transmitted information; selecting a resource for transmitting the sidelink information from the resource pool configured based on the configuration information, wherein the selected resource for transmitting the sidelink information is a resource included in a specific resource pool portion which is associated with a type of the sidelink information among the at least two resource pool portions; and transmitting the sidelink information on the selected resource.

Furthermore, further comprising: receiving information on a number of at least one terminal associated with the resource pool.

Furthermore, further comprising: generating the sidelink information,
wherein a number of total sidelink information transmitted on the resource pool is determined based on a ratio value dividing a number of terminal performing sidelink transmission among the at least one terminal associated with the resource pool by the number of the at least one terminal associated with the resource pool.

Furthermore, wherein the ratio value is determined from values included in a pre-defined range.

Furthermore, wherein in case that a number of the at least two resource pool portions is 2, one resource pool portion is associated with sidelink information of a first type, and other resource pool portion is associated with sidelink information of a second type which is different from the first type.

Furthermore, wherein the other resource pool portion associated with the sidelink information of the second type is configured to be a region excluding the one resource pool portion associated with the sidelink information of the first type from a whole resource region of the resource pool.

Furthermore, wherein the sidelink information of the first type is DENM (decentralized environmental notification messages), and wherein the sidelink information of the second type is CAM (cooperative awareness message).

Furthermore, wherein resources included in each of the at least two resource pool portions are indexed by an identifier, respectively.

Furthermore, further comprising: reselecting the resource for transmitting the sidelink information in case that the selected resource for transmitting the sidelink information is not a resource included in the specific resource pool portion associated with the type of the sidelink information.

Furthermore, wherein the reselecting the resource for transmitting the sidelink information is performed iteratively until the reselected resource for the sidelink information is determined to be a resource included in the specific resource pool portion associated with the type of the sidelink information.

Furthermore, a terminal for performing a sidelink transmission in a wireless communication system, the terminal comprising: one or more transmitters and receivers; one or more processors; and one or more memories associated with the one or more processors, storing instructions for operations executed by the one or more processors, wherein the operations comprise, receiving configuration information associated with configuration of a resource pool including resources for transmitting the sidelink information, wherein the resource pool is configured to be separated into at least two resource pool portions distinguished based on a type of transmitted information; selecting a resource for transmitting the sidelink information from the resource pool configured based on the configuration information, wherein the selected resource for transmitting the sidelink information is a resource included in a specific resource pool portion which is associated with a type of the sidelink information among the at least two resource pool portions; and transmitting the sidelink information on the selected resource.

Furthermore, an apparatus comprising one or more memories and one or more processors functionally coupled to the one or more memories, wherein the one or more processors controls the apparatus to: receive configuration information associated with configuration of a resource pool including resources for transmitting the sidelink information, wherein the resource pool is configured to be separated into at least two resource pool portions distinguished based on a type of transmitted information; select a resource for transmitting the sidelink information from the resource pool configured based on the configuration information, wherein the selected resource for transmitting the sidelink information is a resource included in a specific resource pool portion which is associated with a type of the sidelink information among the at least two resource pool portions; and transmit the sidelink information on the selected resource.

Furthermore, a non-transitory computer-readable medium storing one or more instructions, the one or more instructions executable by one or more processors controls a terminal to: receive configuration information associated with configuration of a resource pool including resources for transmitting the sidelink information, wherein the resource pool is configured to be separated into at least two resource pool portions distinguished based on a type of transmitted information; select a resource for transmitting the sidelink information from the resource pool configured based on the configuration information, wherein the selected resource for transmitting the sidelink information is a resource included in a specific resource pool portion which is associated with a type of the sidelink information among the at least two resource pool portions; and transmit the sidelink information on the selected resource.

### Advantageous Effects

The present disclosure has the effect of enabling sidelink information to be transmitted in a wireless communication system.

Furthermore, the present disclosure has the effect of enabling a terminal performing a sidelink transmission to select an appropriate resource according to the type of information to be transmitted by establishing a resource pool that is categorized according to message information.

The effects that can be obtained from the present disclosure are not limited to the effects mentioned above, and other effects that have not been mentioned will be clearly understood by one having ordinary knowledge in the technical field to which the present invention belongs from the following description.

### DESCRIPTION OF DRAWINGS

The accompanying drawings, which are incorporated as part of the detailed description to facilitate an understanding of the present disclosure, provide embodiments of the present disclosure and, together with the detailed description, describe technical features of the present disclosure.

FIG. 1 illustrates an example of a wireless network in accordance with embodiments of the present disclosure.

FIG. 2 illustrates an example of a base station, in accordance with embodiments of the present disclosure.

FIG. 3 illustrates an example of a terminal according to embodiments of the present disclosure.

FIG. 4 is a diagram illustrating a basic structure of a time-frequency domain, a radio resource domain in which data or control channels are transmitted in an NR system according to one embodiment of the present disclosure.

FIGS. 5 and 6 schematically illustrate the structure of a radio frame as applied to the present disclosure.

FIG. 7 is a diagram illustrating an example of performing sidelink communication.

FIG. 8 is a diagram to illustrate the concept of cellular network-based D2D communication as applied to the present disclosure.

FIG. 9 is a drawing illustrating a system according to one embodiment of the present disclosure.

FIG. 10 is a drawing to illustrate a resource pool, defined as a set of time and frequency resources used for transmitting and receiving sidelinks in accordance with one embodiment of the present disclosure.

FIG. 11 is a flow diagram to illustrate a method of scheduled resource allocation (mode 1) in a sidelink according to one embodiment of the present disclosure.

FIG. 12 is a flow diagram to illustrate a method of UE autonomous resource allocation (mode 2) in a sidelink, according to one embodiment of the present disclosure.

FIG. 13 is an illustration of one example of a resource pool configuration for sidelink transfers.

FIG. 14 is a diagram illustrating one example of a resource pool setting proposed in the present disclosure.

FIG. 15 is a diagram illustrating an example of a resource initialization and resource selection operation of a terminal according to the method proposed in the present disclosure.

FIG. 16 is a flow diagram illustrating an example of how a method for transmitting sidelink information proposed in the present disclosure is performed in a terminal.

### MODE FOR INVENTION

In various embodiments of the present disclosure, “/” and “,” should be interpreted to indicate “and/or”. For example, “A/B” may mean “A and/or B”. Further, “A, B” may mean “A and/or B”. Further, “A/B/C” may mean “at least one of A, B, and/or C”. Further, “A, B, C” may mean “at least one of A, B, and/or C”.

In various embodiments of the present disclosure, “or” should be interpreted to mean “and/or”. For example, “A or B” may include “only A”, “only B”, and/or “both A and B”. In other words, “or” should be interpreted to mean “additionally or alternatively”.

The following technologies can be used in various wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and the like. CDMA can be implemented in radio technologies such as universal terrestrial radio access (UTRA) or CDMA2000. TDMA can be implemented in wireless technologies such as GSM (global system for mobile communications)/GPRS (general packet radio service)/EDGE (enhanced data rates for GSM evolution). OFDMA can be implemented in wireless technologies such as IEEE (institute of electrical and electronics engineers) 802.11 (Wi-Fi), IEEE 802.16 (WiMAX), IEEE 802-20, E-UTRA (evolved UTRA), etc. IEEE 802.16m is an evolution of IEEE 802.16e and provides backward compatibility with systems based on IEEE 802.16e. UTRA is part of the universal mobile telecommunications system (UMTS). The 3rd generation partnership project (3GPP) LTE (long term evolution) is part of E-UMTS (evolved UMTS) using E-UTRA (evolved-UMTS terrestrial radio access), which employs OFDMA in the downlink and SC-FDMA in the uplink. LTE-A (advanced) is an evolution of 3GPP LTE.

5G NR is the successor to LTE-A and is a new clean-slate mobile communication system with characteristics such as high performance, low latency, and high availability. 5G NR can utilize all available spectrum resources, from the low frequency bands below 1 GHz to the mid-frequency bands from 1 GHz to 10 GHz and the high frequency (millimeter wave) bands above 24 GHz.

For clarity of description, LTE-A or 5G NR will be described, but the technical ideas of one embodiment of the present disclosure are not limited thereto.

In order to meet the growing demand for wireless data traffic since the commercialization of 4G communication systems, efforts are being made to develop improved 5G communication systems or pre-5G communication systems. For this reason, 5G communication systems or pre-5G communication systems are often referred to as Beyond 4G Network (Beyond 4G Network) communication systems or Post LTE (Post LTE) systems. The 5G communication system defined by 3GPP is called the New Radio (NR) system. To achieve high data rates, 5G communication systems are being considered for implementation in ultra-high frequency (mmWave) bands (e.g., 60 GHz). In order to mitigate the path loss of radio waves in the ultra-high frequency band and increase the transmission distance of radio waves, beamforming, massive MIMO, full dimensional MIMO (FD-MIMO), array antenna, analog beam-forming, and large scale antenna techniques have been discussed and applied to NR systems in 5G communication systems. In addition, to improve the network of the system, 5G communication systems are developing technologies such as advanced small cell, improved small cell, cloud radio access network (cloud RAN), ultra-dense network, device to device communication (D2D), wireless backhaul, moving network, cooperative communication, coordinated multi-points (COMP), and interference cancellation. In addition, advanced coding modulation (ACM) schemes such as FQAM (Hybrid FSK and QAM Modulation) and SWSC (Sliding Window Superposition Coding) are being developed for 5G systems, as well as advanced access technologies such as FBMC (Filter Bank Multi Carrier), NOMA (non-orthogonal multiple access), and SCMA (sparse code multiple access).

Meanwhile, the Internet is evolving from a human-centered network of connections where humans create and consume information to an Internet of Things (IoT) network where information is exchanged and processed among distributed components such as objects. Internet of Everything (IoE) technology, which combines IoT technology with big data processing technology through connections to cloud servers, is also emerging. To realize IoT, technology elements such as sensing technology, wired and wireless communication and network infrastructure, service interface technology, and security technology are required, and recently, technologies such as sensor network, machine to machine (M2M), and machine type communication (MTC) have been researched for connecting objects. In the IoT environment, intelligent IT (Internet Technology) services that create new value for human life by collecting and analyzing data generated by connected objects can be provided. IoT can be applied to fields such as smart homes, smart buildings, smart cities, smart or connected cars, smart grids, healthcare, smart appliances, and advanced medical services through convergence and complexity between existing information technology (IT) and various industries.

Therefore, various attempts are being made to apply 5G communication systems to IoT networks. For example, technologies such as sensor network, machine to machine (M2M), and machine type communication (MTC) are being implemented using 5G communication technologies such as beamforming, MIMO, and array antennas. The application of cloud radio access network (cloud RAN) as a big data processing technology described above is also an example of the convergence of 5G and IoT technologies.

On the other hand, NR (New Radio access technology), a new 5G communication, is designed to allow various services to be freely multiplexed in time and frequency resources, so that waveforms/numerology, reference signals, etc. can be dynamically or freely allocated according to the needs of the service. In wireless communication, optimized data transmission through measurement of channel quality and interference is important to provide optimal services to terminals, and accurate channel state measurement is essential. However, unlike 4G communication, where the channel and interference characteristics do not change significantly depending on the frequency resource, 5G channels require the support of a subset of frequency resource groups (FRGs) that can be divided and measured, as the channel and interference characteristics change significantly depending on the service. On the other hand, the types of services supported in NR systems can be divided into categories such as enhanced mobile broadband (eMBB), massive Machine Type Communications (mMTC), and Ultra-Reliable and low-latency Communications (URLLC). eMBB is a high-speed transmission of high-capacity data, mMTC is a service aimed at minimizing terminal power and connecting multiple terminals, and URLLC is a service aimed at high reliability and low latency. Depending on the type of service applied to a terminal, different requirements may be applied.

As such, a plurality of services may be provided to a user in a communication system, and in order to provide such a plurality of services to a user, a method and apparatus that can provide each service within the same time window according to its characteristics are required.

Hereinafter, embodiments of the present disclosure will be described in detail with reference to the accompanying drawings.

In describing the embodiments, technical details that are well known in the technical field to which the present disclosure belongs and that are not directly related to the present disclosure will be omitted. This is done to make the disclosure clearer without obscuring the main points of the disclosure by omitting unnecessary explanations.

For the same reason, in the accompanying drawings, some components are exaggerated, omitted, or shown schematically. Also, the dimensions of each component are not intended to be entirely reflective of its actual size. In each drawing, identical or corresponding components are given the same reference numerals.

The advantages and features of the present disclosure, and methods of achieving them, will become apparent upon reference to the embodiments described in detail with reference to the accompanying drawings. However, the disclosure is not limited to the embodiments disclosed herein, but may be embodied in many different forms, and these embodiments are provided merely to make the disclosure complete and to give those of ordinary skill in the art to which the disclosure belongs a complete idea of the scope of the disclosure, which is defined by the claims. Throughout the disclosure, the same reference numerals refer to the same components.

At this point, it will be understood that each block of the processing flowchart illustrations and combinations of the flowchart illustrations may be performed by computer program instructions. These computer program instructions may be loaded into a processor of a general purpose computer, a special purpose computer, or other programmable data processing equipment, such that the instructions, when executed by the processor of the computer or other programmable data processing equipment, create means for performing the functions described in the flowchart block(s). The computer program instructions may be stored in computer-available or computer-readable memory that may direct the computer or other programmable data processing equipment to perform the functions in a particular manner, so that the instructions stored in the computer-available or computer-readable memory may produce an article of manufacture comprising the instructional means for performing the functions described in the flowchart block(s). The computer program instructions can also be loaded onto a computer or other programmable data processing equipment, such that a sequence of operational steps is performed on the computer or other programmable data processing equipment to create a computer-executable process, such that the instructions for performing the computer or other programmable data processing equipment provide steps for performing the functions described in the flowchart block(s).

Further, each block may represent a module, segment, or portion of code that includes one or more executable instructions for performing a particular logical function(s). It should also be noted that in some alternative execution examples, the functions mentioned in the blocks may occur out of sequence. For example, two blocks shown one after the other may in fact be performed substantially simultaneously, or the blocks may be performed in reverse order, depending on the functions they sometimes perform.

As used herein, the term “part” refers to software or a hardware component, such as an FPGA or ASIC, that performs some function. However, “part” is not limited to software or hardware. The “~ part” may be configured to be on an addressable storage medium or may be configured to reproduce one or more processors. Thus, in one example, “part” includes components, such as software components, object-oriented software components, class components, and task components, processes, functions, attributes, procedures, subroutines, segments of program code, drivers, firmware, microcode, circuits, data, databases, data structures, tables, arrays, and variables. The functionality provided within components and parts may be combined into fewer components and parts or further separated into additional components and parts. Furthermore, the components and parts may be implemented to play one or more CPUs within the device or secure multimedia card. Furthermore, in embodiments, the “to part” may include one or more processors.

Wireless communication systems have evolved from providing initially voice-oriented services to broadband wireless communication systems that provide high-speed, high-quality packet data services, for example, using communication standards such as 3GPP's high speed packet access (HSPA), LTE (long term evolution or evolved universal terrestrial radio access (E-UTRA), LTE-Advanced (LTE-A), 3GPP2's high rate packet data (HRPD), ultra mobile broadband (UMB), and IEEE's 802.16e. In addition, 5G or NR (new radio) communication standards are being created as the fifth generation wireless communication system.

As a typical example of a broadband wireless communication system, the NR system employs orthogonal frequency division multiplexing (OFDM) in the downlink (DL) and uplink (UL). More specifically, CP-OFDM (cyclic-prefix OFDM) is adopted for the downlink, and CP-OFDM and DFT-S-OFDM (discrete Fourier transform spreading OFDM) are adopted for the uplink. The uplink refers to a wireless link that transmits data or control signals from the terminal (user equipment (UE) or mobile station (MS)) to the base station (gNode B, or base station (BS)), and the downlink refers to a wireless link that transmits data or control signals from the base station to the terminal. In the above multiple access method, the data or control information of each user is usually distinguished by allocating and operating the time and frequency resources to carry data or control information for each user so that orthogonality is established.

### Wireless Networks General

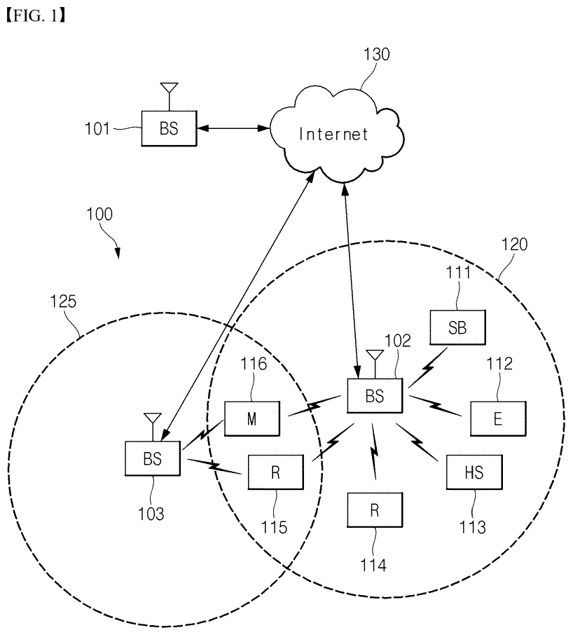

FIGS. 1-3 illustrate various embodiments implemented in the wireless communication systems disclosed below and using orthogonal frequency division multiplexing (OFDM) or orthogonal frequency division multiple access.

FIGS. 1 to 3 are not intended to be physical or structural limitations on how other embodiments may be implemented. Other embodiments of the disclosure may be implemented in any suitably arranged communication system.

FIG. 1 illustrates an example of a wireless network in accordance with embodiments of the present disclosure. The example embodiment of the wireless network shown in FIG. 1 is for illustrative purposes only. Other embodiments of the wireless network 100 may be used without departing from the scope of the present disclosure.

As shown in FIG. 1, the wireless network may include a gNB 101, a gNB 102, and a gNB 103. Further, gNB 101 may be in communication with at least one network 103, such as the internet, a proprietary internet protocol (IP) network, or another data network.

The gNB 102 may provide wireless broadband access to the network 130 for a first plurality of user equipment (UE) within the coverage area 120 of the gNB 102. The first plurality of user equipment may include a user device 111 that may be located at a small business (SB), a user device 112 that may be located at an enterprise (E), a user device 113 that may be located at a WIFI hotspot (HS), a UE that may be located at a first residence (residence, R), UE 114, which may be located in a second residence, UE 115, which may be located in a third residence, and UE 115, which may be located in a mobile device, such as, for example, a cell phone, a wireless laptop, a wireless PDF, or the like.

The gNB 103 may provide wireless broadband access to the network 130 for a second plurality of UEs within the coverage area 125 of the gNB 103. The second plurality of UEs may include UE 115, UE 116, and so forth. According to one embodiment, the at least one or more gNBs 101-103 may communicate with each other and with the UEs 111-116 using 5G, LTE, LTE-A, WiMAX, WIFI, or other wireless communication technologies.

Depending on the type of network, the term “base station” or “base station” or “BS” may refer to any component (or collection of components) configured to provide wireless access to a network, such as a transmit point (TP), a transmit-receive point (TRP), an enhanced base station (eNodeB or eNB), a 5G base station (gNB), a macrocell, a femtocell, a WiFi access point (AP), or other wireless-enabled device.

A base station may provide wireless access according to one or more wireless communication protocols, e.g., 5G 3GPP new radio interface/access (NR), long-term evolution (LTE), LTE advanced (LTE-A), high-speed packet access (HSPA)), Wi-Fi 802.11a/b/g/n/ac, etc. For convenience, the terms “BS” and “TRP” are used interchangeably in this patent document to refer to network infrastructure components that provide wireless access to remote terminals. In addition, depending on the type of network, the term “user equipment” or “UE” may refer to any component, such as a “mobile station”, “subscriber”, “remote terminal”, “wireless terminal”, “receiving point”, or “user device”.

For convenience, the terms “user equipment” and “UE” are used in this patent document to refer to remote wireless equipment that wirelessly accesses the BS, wherein the UE is a mobile device (e.g., a mobile phone or smartphone) or is generally considered to be a fixed device (e.g., a desktop computer or vending machine).

The dashed lines indicate the approximate extent of coverage areas 120, and 125, which are shown as roughly circular for illustration and explanation only. Coverage areas 120 and 125 associated with a gNB may have different shapes, including irregular shapes, depending on the configuration of the gNB and variations in the wireless environment associated with natural and man-made obstacles.

As described in more detail below, the at least one or more UEs 111-116 may include circuitry, programming, or combinations thereof for reliable reception of data and control information in advanced wireless communication systems. In certain embodiments, the at least one or more gNBs 101-103 may include circuitry, programming, or combinations thereof for efficient network control resource allocation in new radio (NR) vehicle-to-everything (V2X).

FIG. 1 illustrates one example of a wireless network, but various modifications may be made to FIG. 1. For example, the wireless network may include any number of gNBs and any number of UEs in any suitable arrangement. Further, the gNBs 101 may communicate directly with any number of UEs and provide those UEs with wireless broadband access to the network 130. Similarly, each of gNBs 102-103 may communicate directly with network 130 and may provide UEs with direct wireless broadband access to network 130. Further, gNBs 101, 102, and/or 103 may provide access to other or additional external networks, such as external telephone networks or other types of data networks.

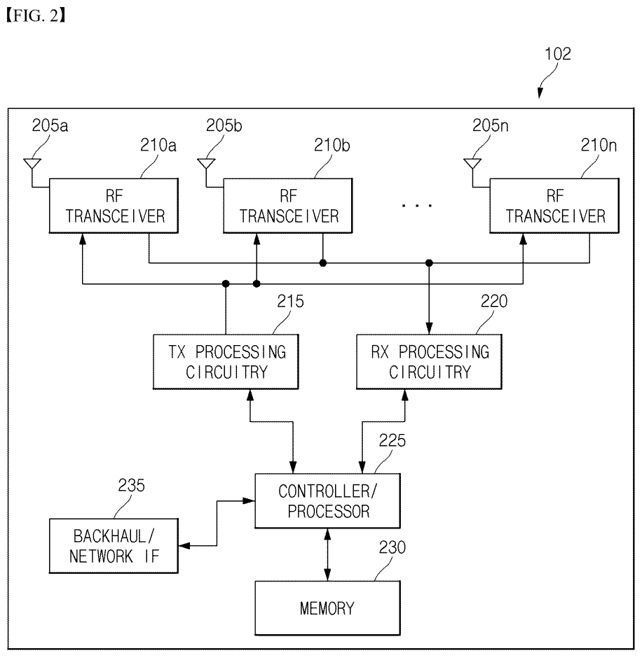

FIG. 2 illustrates an example of a gNB 102, in accordance with embodiments of the present disclosure. The embodiment of gNB 102 illustrated in FIG. 1 is for illustrative purposes only, and gNB 101 and gNB 103 of FIG. 1 may have the same or similar configurations. However, gNBs can be provided in a variety of configurations, and FIG. 2 does not limit the scope of the disclosure to any particular implementation of a gNB.

As shown in FIG. 2, the gNB 102 may include multiple antennas 205a-205n, multiple radio frequency (RF) transceivers 210a-210n, transmit (TX) processing circuitry 215, and receive (RX) processing circuitry 220. The gNB 102 may also include a controller/processor 225, memory 230, and a backhaul or network interface (network IF) 235.

RF transceivers 210a-210n may receive incoming RF signals, such as signals transmitted by UEs in network 100, from antennas 205a-205n. The RF transceivers 210a-210n may down-convert the incoming RF signals to generate intermediate frequency (IF) or baseband signals. The IF or baseband signals may be transmitted to RX processing circuit 220, which may generate processed baseband signals by filtering, decoding, and/or digitizing. RX processing circuit 220 may transmit the processed baseband signals to controller/processor 225 for further processing.

TX processing circuit 215 may receive analog or digital data (e.g., voice data, web data, email, interactive video game data) from controller/processor 225. TX processing circuitry 215 may encode, multiplex, and/or digitize the outgoing baseband data to generate processed baseband or IF signals.

Controller/processor 225 may include at least one processor or other processing unit that controls the overall operation of the gNB 102. For example, controller/processor 225 may control the reception of forward channel signals and transmission of reverse channel signals by RF transceivers 210a-210n, RX processing circuit 220, and TX processing circuit 215 according to well-known principles. Controller/processor 225 may also support additional functionality, such as more advanced wireless communication capabilities. For example, controller/processor 225 may support beam forming or directional routing operations where signals from multiple antennas 205a-205n are weighted differently to effectively steer them in a desired direction. Any of a variety of other functions may be supported by the controller/processor 225 in the gNB 102.

The controller/processor 225 can also execute programs and other processes residing in memory 230, such as an operating system (OS). The controller/processor 225 can move data in and out of memory 230 as required by the executing process.

In addition, controller/processor 225 may be connected to a backhaul or network interface 235. The backhaul or network interface 235 enables the gNB 102 to communicate with other devices or systems over a backhaul connection or network. Interface 235 may support communication over any suitable wired or wireless connection(s). For example, when the gNB 102 is implemented as part of a cellular communication system (e.g., supporting 5G, LTE, or LTE-A), the interface 235 may allow the gNB 102 to communicate with other gNBs over a wired or wireless backhaul connection. When the gNB 102 is implemented as an access point, the interface 235 may allow the gNB 102 to communicate with a wired or wireless local area network, or to a larger network (e.g., the Internet) over a wired or wireless connection. The interface 235 can include any suitable structure that supports communication over a wired or wireless connection, such as an Ethernet or RF transceiver.

Memory 230 may be coupled to controller/processor 225. A portion of memory 230 may include RAM, and other portions of memory 230 may include flash memory or other ROM.

While FIG. 2 illustrates one example of a gNB 102, various modifications can be made to FIG. 2. For example, the gNB 102 may include any number of each of the components shown in FIG. 2. As a specific example, the access point may include multiple interfaces 235, and the controller/processor 225 may support routing functionality for routing data between different network addresses. As another specific example, although shown as including a single instance of TX processing circuitry 215 and a single instance of RX processing circuitry 220, gNB 102 may include multiple instances of each (e.g., one per RF transmitter and receiver).

Further, the various components of FIG. 2 may be combined, further subdivided, or omitted, and additional components may be added based on specific needs.

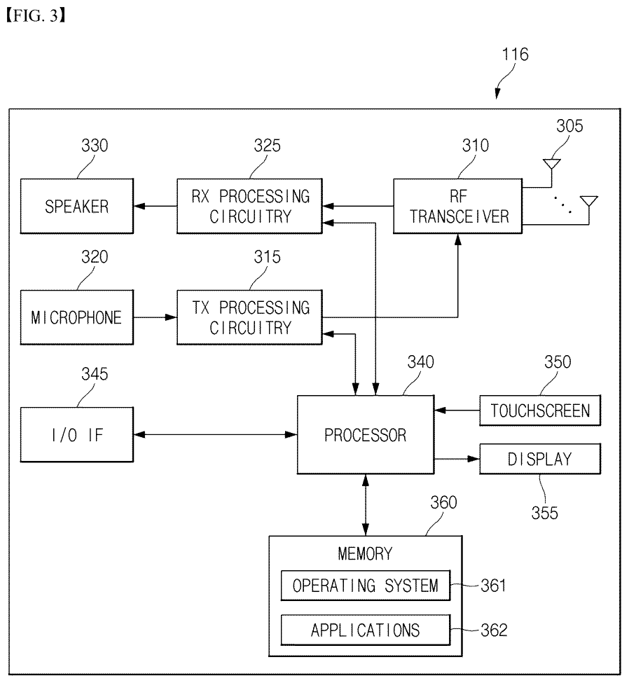

FIG. 3 illustrates an exemplary UE 116, in accordance with embodiments of the present disclosure. The embodiment of UE 116 shown in FIG. 3 is for illustrative purposes only, and may have the same or similar configuration as UEs 111-115 of FIG. 1. However, UEs are provided in a variety of configurations, and FIG. 3 does not limit the scope of this disclosure to any particular implementation of a UE.

As shown in FIG. 3, UE 116 may include antenna 305, radio frequency (RF) transceiver 310, transmit (TX) processing circuitry 315, microphone 320, and receive (RX) processing circuitry 325. The UE 116 may also include a speaker 330, a processor 340, an input/output (I/O) interface (IF) 345, a touch screen 350, a display 355, and a memory 360. Memory 360 may include an operating system (OS) 361 and one or more applications 362.

RF transceiver 310 can receive incoming RF signals transmitted by a gNB of network 100 from antenna 305. RF transceiver 310 can down-convert the incoming RF signal to generate intermediate frequency (IF) or baseband signals. The IF or baseband signals may be transmitted to RX processing circuit 325, which may generate baseband signals that are processed by filtering, decoding, and/or digitizing. RX processing circuit 325 may transmit the processed baseband signal to speaker 330 (e.g., speech data) or processor 340 for further processing (e.g., web browsing data).

TX processing circuit 315 can receive analog or digital voice data from microphone 320 or other outgoing baseband data (such as web data, email, or interactive video game data) from processor 340. TX processing circuitry 315 can encode, multiplex, and/or digitize the outgoing baseband data to generate a processed baseband or IF signal.

RF transceiver 310 may receive the transmit processed baseband or IF signal from TX processing circuit 315 and may up-convert the baseband or IF signal to an RF signal transmitted via antenna 305.

Processor 340 may include one or more processors or other processing devices and may execute OS 361 stored in memory 360 to control the overall behavior of UE 116. For example, controller/processor 225 may control the reception of forward channel signals and transmission of reverse channel signals by RF transceivers 210a-210n, RX processing circuit 220, and TX processing circuit 215 according to well-known principles. According to some embodiments, processor 340 may include one or more microprocessors or microcontrollers.

Additionally, processor 340 may execute other processes and programs residing in memory 360, such as processes for beam management. The processor 340 can move data into and out of memory 360 as required by the executing process. In one embodiment, processor 340 may be configured to execute application 362 based on OS 361 or in response to signals received from the gNB or an operator.

Further, the processor 340 may be connected to an I/O interface 345, which may provide the UE 116 with the ability to connect to other devices, such as laptop computers and handheld computers.

Additionally, processor 340 may be coupled to touch screen 350 and display 355. An operator of the UE 116 may use the touch screen 350 to enter data into the UE 116. Display 355 may be a liquid crystal display, light emitting diode display, or other display capable of rendering text and/or at least limited graphics, such as a website.

Memory 360 may be coupled to processor 340. A portion of memory 360 may include random access memory (RAM), and another portion of memory 360 may include flash memory or other read-only memory (ROM).

FIG. 3 illustrates one example of UE 116, which may be subject to various modifications. For example, various components of FIG. 3 may be combined, further subdivided, or omitted, and additional components may be added based on specific needs. As a specific example, processor 340 may be divided into multiple processors, such as one or more central processing units (CPUs) and one or more graphics processing units (GPUs). Further, FIG. 3 illustrates a UE 116 configured as a mobile phone or smartphone, although the UE may be configured to operate as any other type of mobile or fixed device.

The present disclosure relates generally to wireless communication systems, and more specifically to vehicular communication network protocols, including vehicle-to-device, vehicle-to-vehicle, and vehicle-to-network communication resource allocation and synchronization schemes.

The communication system may include a downlink (DL) that carries signals from a transmitting point, such as a base station (BS) or NodeB, to user equipment (UE), and an uplink (UL) that carries signals from UE to a receiving point, such as a NodeB.

Additionally, sidelinks (SLs) may carry signals from UEs to other UEs or other non-infrastructure-based nodes. UEs, also commonly referred to as terminals or mobile stations, can be fixed or mobile and can be cell phones, personal computer devices, and the like. NodeBs, which are typically fixed stations, may also be referred to by other equivalent terms such as access points or eNodeBs. The access network that includes the NodeBs associated with 3GPP LTE is referred to as the Evolved Universal Terrestrial Access Network (E-UTRAN).

### NR System Related

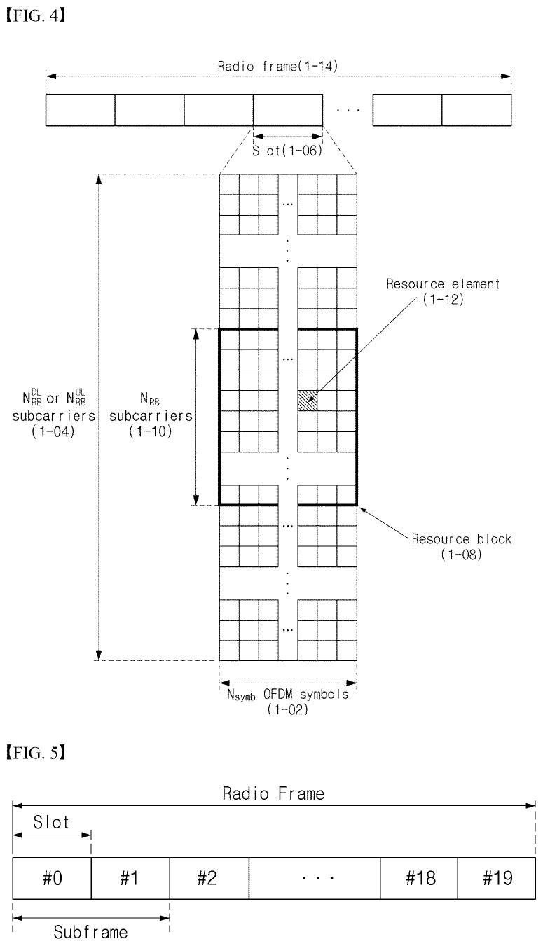

FIG. 4 is a diagram illustrating a basic structure of a time-frequency domain, which is a radio resource domain over which data or control channels are transmitted in an NR system according to one embodiment of the present disclosure.

Specifically, FIG. 4 illustrates a basic structure of a time-frequency domain, which is a radio resource domain over which data or control channels are transmitted in a downlink or uplink in an NR system.

Referring to FIG. 4, the horizontal axis represents the time domain and the vertical axis represents the frequency domain. The minimum transmission unit in the time domain is an OFDM symbol, and Nsymb of OFDM symbols 1-02 can be gathered to form one slot 1-06. The length of a subframe is defined as 1.0 ms, and a radio frame 1-14 is defined as 10 ms. The smallest unit of transmission in the frequency domain is a subcarrier, and the bandwidth of the entire system transmission bandwidth may comprise a total of NBW subcarriers 1-04.

The basic unit of a resource in the time-frequency domain is a resource element (1-12, resource element; RE), which may be represented by an OFDM symbol index and a subcarrier index. A resource block (1-08, resource block; RB or physical resource block; PRB) may also be defined as Nsymb contiguous OFDM symbols (1-02) in the time domain and NRB contiguous subcarriers (1-10) in the frequency domain. Thus, one RB 1-08 may comprise Nsymb x NRB of REs 1-12. In general, the smallest unit of data transmission is the RB unit. In NR systems, typically Nsymb=14, NRB=12, and NBW and NRB may be proportional to the bandwidth of the system transmission band. In addition, the data rate may be proportional to the number of RBs scheduled for the terminal.

In an NR system, the downlink and uplink transmission bandwidths may be different from each other in an FDD system where the downlink and uplink are frequency separated. The channel bandwidth can represent the RF bandwidth corresponding to the system transmission bandwidth. [Table 1 and Table 2 show some of the correspondences between system transmission bandwidth, subcarrier spacing, and channel bandwidth as defined for NR systems in frequency bands lower than 6 GHz and higher than 6 GHz, respectively. For example, an NR system with a 100 MHz channel bandwidth with a 30 kHz subcarrier width has a transmission bandwidth of 273 RBs. In the following, N/A can be any bandwidth-subcarrier combination that is not supported by the NR system.

TABLE 1

| Channel | | | | | | | |
|---|---|---|---|---|---|---|---|
| bandwidth | Subcarrier | | | | | | |
| BW_{Channel}[MHz] | spacing | 5 MHz | 10 MHz | 20 MHz | 50 MHz | 80 MHz | 100 MHz |
| Transmission | 15 kHz | 25 | 52 | 106 | 270 | N/A | N/A |
| bandwidth | 30 kHz | 11 | 24 | 51 | 133 | 217 | 273 |
| configuration | 60 kHz | N/A | 11 | 24 | 65 | 107 | 135 |
| N_{RB} | | | | | | | |

TABLE 2

| Channel bandwidth | Subcarrier | 50 | 100 | 200 | 400 |
|---|---|---|---|---|---|
| BW_{Channel}[MHz] | spacing | MHz | MHz | MHz | MHz |
| Transmission bandwidth | 60 kHz | 66 | 132 | 264 | N/A |
| configuration N_{RB} | 120 kHz | 32 | 66 | 132 | 264 |

In NR systems, the frequency range can be defined as FR1 and FR2, divided as shown in Table 3 below.

TABLE 3

| Frequency range | |
|---|---|
| designation | Corresponding frequency range |
| FR1 | 450 MHz-7125 MHz |
| FR2 | 24250 MHz-52600 MHz |

The ranges of FR1 and FR2 can also be changed and applied differently. For example, the frequency range of FR1 may be varied from 450 MHz to 6000 MHz.

In NR systems, scheduling information for downlink data or uplink data is communicated from the base station to the terminal via downlink control information (DCI). DCI can be defined according to different formats, each of which can indicate whether it is scheduling information for uplink data (UL grant) or downlink data (DL grant), whether it is a compact DCI where the size of the control information is below a certain size, whether spatial multiplexing using multiple antennas is applied, whether it is DCI for power control, etc. For example, the scheduling control information (DL grant) for downlink data, DCI format 1-1, may include at least one of the following control information

Carrier indicator: indicates on which frequency carrier the data is to be transmitted.

DCI format indicator: indicates whether the DCI is for downlink or uplink.

Bandwidth part (BWP) indicator: Indicates which BWP it is transmitted on.

Frequency domain resource allocation: Indicates the RB of the frequency range allocated for data transmission. The system bandwidth and resource allocation method determines the resources represented.

Time Domain Resource Allocation: Indicates which OFDM symbols in which slot will transmit the data-related channels.

VRB-to-PRB mapping: dictates how the virtual RB (VRB) index and physical RB (PRB) index are mapped.

Modulation and coding scheme (MCS): Specifies the modulation scheme used for data transmission and the size of the transport block, which is the data to be transmitted.

HARQ process number: Specify the HARQ process number.

new data indicator: Indicates whether the HARQ is initialized or retransmitted.

redundancy version: Indicates the redundancy version of the HARQ.

transmit power control (TPC) command for PUCCH (physical uplink control channel): Specifies the transmit power control command for the uplink control channel, PUCCH.

For data transmission via PDSCH or PUSCH, the time domain resource assignment can be determined by information about the slot in which the PDSCH/PUSCH is transmitted, the starting symbol position S in that slot, and the number of symbols L to which the PDSCH/PUSCH is mapped. S may be a position relative to the start of the slot, L may be a number of consecutive symbols, and S and L may be determined from a start and length indicator value (SLIV) defined as follows.

TABLE 4

```
if (L − 1) ≤ 7 then
  SLIV = 14 · (L − 1) + S
else
  SLIV = 14 · (14 − L + 1) + (14 − 1 − S)
where 0 < L ≤ 14 − S
```

In the NR system, the terminal may receive information about the SLIV value, the PDSCH/PUSCH mapping type, and the slot in which the PDSCH/PUSCH is transmitted in one row through the RRC setting (e.g., the information may be set in the form of a table). In the subsequent time domain resource allocation of the DCI, the base station may communicate the information about the SLIV value, the PDSCH/PUSCH mapping type, and the slot in which the PDSCH/PUSCH is transmitted to the terminal by indicating the index value in the set table.

In the NR system, PDSCH mapping type can be defined as type A and type B. The base station can send information to the terminal about the SLIV value, PDSCH/PUSCH mapping type, and the slot to which PDSCH/PUSCH is transmitted. According to PDSCH mapping type A, the first of the DMRS symbols may be located in the second or third OFDM symbol of the slot. According to PDSCH mapping type B, the first of the DMRS symbols may be located in the first OFDM symbol in the time domain resource allocated by the PUSCH transmission.

The DCI may be transmitted on the physical downlink control channel (PDCCH), which is the downlink physical control channel after channel coding and modulation. In this disclosure, when control information is transmitted over a PDCCH or PUCCH, it may be referred to as being transmitted over a PDCCH or PUCCH. Similarly, the disclosure may refer to data being transmitted over PUSCH or PDSCH as PUSCH or PDSCH being transmitted.

In general, the DCI may be scrambled into a specific radio network temporary identifier (RNTI) (or terminal identifier) independently for each terminal, appended with a cyclic redundancy check (CRC), channel coded, and transmitted as separate PDCCHs. The PDCCHs may be mapped and transmitted from a control resource set (CORESET) established by the terminal.

Downlink data may be transmitted on a physical downlink shared channel (PDSCH), which is a physical channel for downlink data transmission. The PDSCH may be transmitted after the control channel transmission section, and scheduling information such as the specific mapping position in the frequency domain and the modulation method may be determined based on the DCI transmitted over the PDCCH.

Among the control information comprising the DCI, the base station may notify the terminal via a modulation coding scheme (MCS) of the modulation scheme applied to the PDSCH to be transmitted and the size of the data to be transmitted (transport block size (TBS)). According to embodiments of the present disclosure, the MCS may consist of 5 bits or more or less bits. The transport block size (TBS) may correspond to the size of the data (transport block, TB) that the base station wishes to transmit before error correction channel coding is applied.

As used herein, a transport block (TB) may include a medium access control (MAC) header, a MAC control element (CE), one or more MAC service data units (SDUs), and padding bits. Alternatively, TB may represent a unit of data to be delivered from the MAC layer down to the physical layer, or a MAC protocol data unit (PDU).

The modulation schemes supported by NR systems are quadrature phase shift keying (QPSK), quadrature amplitude modulation (16QAM), 64QAM, and 256QAM, each with a modulation order (Qm) of 2, 4, 6, or 8. This means that 2 bits per symbol can be transmitted for QPSK modulation, 4 bits per symbol for 16QAM modulation, 6 bits per symbol for 64QAM modulation, and 8 bits per symbol for 256QAM modulation.

### LTE System Related

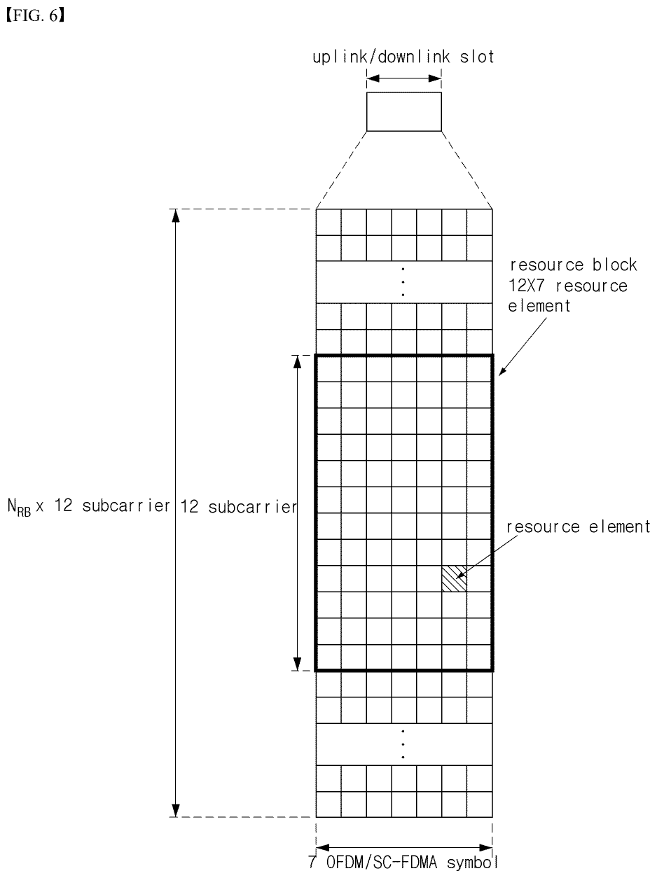

FIGS. 5 and 6 schematically illustrate the structure of a radio frame as applied to the present disclosure.

Referring to FIGS. 5 and 6, a radio frame includes 10 subframes, wherein a subframe includes two consecutive slots. The basic unit of time (length) for transmission control in a radio frame is called the Transmission Time Interval (TTI). A TTI may be 1 ms. A subframe may be 1 ms long and a slot may be 0.5 ms long.

A slot may include a plurality of symbols in the time domain. For example, for a wireless system using Orthogonal Frequency Division Multiple Access (OFDMA) in the downlink (DL), the symbols may be Orthogonal Frequency Division Multiplexing (OFDM) symbols, and for a wireless system using Single Carrier-Frequency Division Multiple Access (SC-FDMA) in the uplink (UL), the symbols may be Single Carrier-Frequency Division Multiple Access (SC-FDMA) symbols. On the other hand, the representation of a symbol period in the time domain is not limited by the multiple access method or designation.

The number of symbols in one slot may vary depending on the length of the Cyclic Prefix (CP). For example, for a normal CP, one slot can contain seven symbols, and for an extended CP, one slot can contain six symbols.

A resource element (RE) represents the smallest time-frequency unit to which modulation symbols on the data channel or modulation symbols on the control channel are mapped. A resource block (RB) is a unit of resource allocation and contains time-frequency resources corresponding to 180 kHz on the frequency axis and 1 slot on the time axis. On the other hand, a resource block pair (PBR) is a resource unit that contains two consecutive slots on the time axis.

At the physical layer, multiple physical channels may be utilized, and physical channels may be mapped to and transmitted in radio frames. As a downlink physical channel, the Physical Downlink Control Channel (PDCCH)/Enhanced PDCCH (EPDCCH) informs the terminal of the resource allocation of the Paging Channel (PCH) and Downlink Shared Channel (DL-SCH) and the Hybrid Automatic Repeat Request (HARQ) information related to the DL-SCH. The PDCCH/EPDCCH can issue uplink grants to inform the terminal of the resource allocation for uplink transmissions. PDCCH and EPDCCH differ in the resource areas they map to. PDSCH (Physical Downlink Shared Channel) is mapped to DL-SCH. The Physical Control Format Indicator Channel (PCFICH) informs the terminal of the number of OFDM symbols used in the PDCCH and is transmitted every subframe. The Physical Hybrid ARQ Indicator Channel (PHICH) is a downlink channel that carries HARQ (Hybrid Automatic Repeat reQuest) ACK (Acknowledgment)/NACK (Non-acknowledgment) signals in response to uplink transmissions. The HARQ ACK/NACK signal may be referred to as the HARQ-ACK signal.

As an uplink physical channel, the Physical Random Access Channel (PRACH) carries the random access preamble. The Physical Uplink Control Channel (PUCCH) carries HARQ-ACK in response to downlink transmissions, channel status information (CSI) indicating the state of the downlink channel, and uplink control information such as channel quality indicator (CQI), precoding matrix index (PMI), precoding type indicator (PTI), rank indicator (RI), etc. The Physical Uplink Shared Channel (PUSCH) carries the Uplink Shared Channel (UL-SCH).

Uplink data may be transmitted on the PUSCH, wherein the uplink data may be a Transport Block (TB), which is a block of data for the UL-SCH transmitted during a Transmission Time Interval (TTI). The transport block may include user data. Alternatively, the uplink data may be multiplexed data. The multiplexed data may be a transport block for UL-SCH and uplink control information multiplexed, i.e., if there is user data to be transmitted uplink, the uplink control information may be multiplexed with user data and transmitted via PUSCH.

### Sidelink (SL) General

The sidelink (SL) refers to the signal transmission and reception path between the terminal and the terminal, which can be used interchangeably with the PC5 interface. base station refers to the entity that performs the resource allocation of the terminal, which may be a base station that supports both V2X communication and regular cellular communication, or a base station that supports V2X communication only, i.e., a base station may be an NR base station (gNB), LTE base station (eNB), or road site unit (RSU) (or fixed station). A terminal can be a typical user equipment, a mobile station, but also a vehicle supporting vehicle-to-vehicle (V2V) communication, a vehicle supporting vehicle-to-pedestrian (V2P) communication, a vehicle or pedestrian's handset (e.g., a smartphone) supporting vehicle-to-network (V2N) communication, or a vehicle supporting vehicle-to-network (V2V) communication, V2N), a vehicle supporting vehicle-to-network (V2N) communication, or a vehicle supporting vehicle-to-infrastructure (V2I) communication, and an RSU equipped with terminal functionality, an RSU equipped with base station functionality, or an RSU equipped with some of the base station functionality and some of the terminal functionality. In the present disclosure, downlink (DL) refers to a wireless transmission path of a signal transmitted by a base station to a terminal, and uplink (UL) refers to a wireless transmission path of a signal transmitted by a terminal to a base station. Furthermore, although one embodiment of the present disclosure is described below based on an NR system, one embodiment of the present disclosure may be applied to a wireless communication system having a similar technical background or channel type. Furthermore, embodiments of the present disclosure may be applied to other communication systems with some modifications that do not substantially depart from the scope of the present disclosure as determined by those skilled in the art.

In this disclosure, the terms physical channel and signal may be used interchangeably with data or control signals. For example, a PDSCH is a physical channel over which data is transmitted, but a PDSCH can also refer to data being transmitted.

As used herein, higher-level signaling refers to a method of signaling from a base station to a terminal using a physical layer downlink data channel, or from a terminal to a base station using a physical layer uplink data channel, and may also be referred to as RRC signaling or MAC control element (CE).

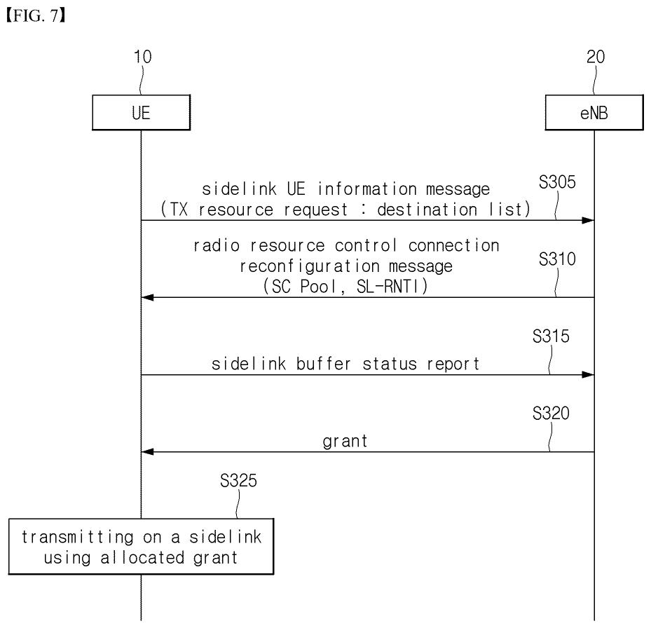

FIG. 7 is an illustration of performing sidelink communication.

Referring to FIG. 7, in order to transmit packets, the UE 10 at the transmit side requires resources (e.g., time and frequency) to transmit sidelink control data and sidelink data. To obtain the resources, the UE 10 interested in sidelink communication may send a sidelink UE information (SidelinkUEInformation) message containing a destination info list (destinationInfoList), i.e., a list of destinations, to the base station, i.e., the eNB 20 (S305).

The eNB 20 may allocate a sidelink resource pool (SC Pool) and sidelink radio network temporary identities (SL-RNTIs) for transmitting sidelink control data via a Radio Resource Control (RRC) connection reconfiguration message (S310). The sidelink resource pool represents time and frequency resources, i.e., at least one or more subframes and physical resource blocks (PRBs) of each subframe, over which sidelink control (scheduling control) data may be transmitted. Time and frequency may be periodically allocated by a sidelink control cycle.

The UE 10 may then transmit a sidelink buffer status report (BSR) to request a dedicated resource for transmitting the sidelink control data and sidelink data (S315).

The eNB 20 may allocate the dedicated resources and transmit information about the dedicated resources, i.e., the grant 201 for the sidelink communication (S320). The received single grant 201 may be for the first available sidelink control cycle starting a certain number of subframes after the subframe at the end of the grant allocation cycle N 220-N in which the single grant 201 was received. The UE 10 may transmit in the first available sidelink control cycle 210 using only one single grant 201 (S325).

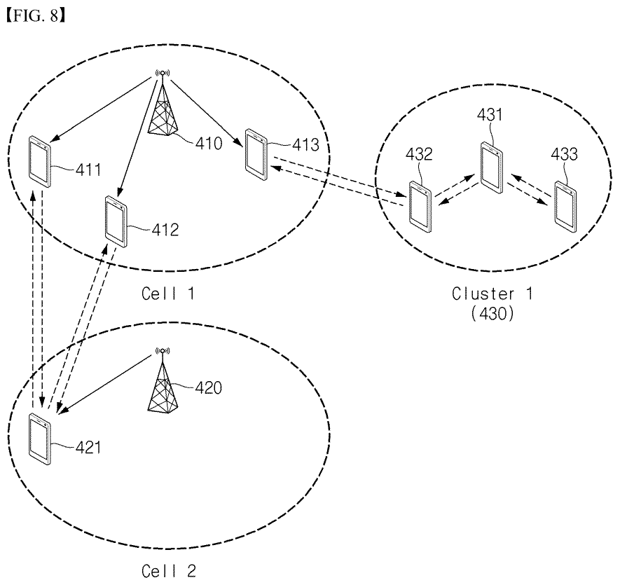

FIG. 8 is a drawing to illustrate concepts of cellular network-based D2D communications applicable to the present disclosure.

Referring to FIG. 8, a cellular communication network including a first base station 410, a second base station 420, and a first cluster 430 is configured. A first terminal 411 and a second terminal 412 belonging to a cell served by the first base station 410 communicate via a conventional access link (cellular link) through the first base station 410. This is an in-coverage-single-cell end-to-end communication scenario. On the other hand, the first terminal 411 belonging to the first base station 410 may perform end-to-end communication with the fourth terminal 421 belonging to the second base station 420. This is an in-coverage-multi-cell end-to-end communication scenario. Additionally, the fifth terminal 431 that is out of network coverage may form a cluster 430 with the sixth terminal 432 and seventh terminal 433 and perform end-to-end communication with them. This is an out-of-coverage end-to-end communication scenario. Additionally, the third terminal 413 may perform end-to-end communication with the sixth terminal 432, which is a partial-coverage end-to-end communication scenario. These end-to-end communication links can be between devices that have the same cell as a serving cell, between devices that have different cells as serving cells, between devices connected to a serving cell and devices that are not connected to a serving cell, or between devices that are not connected to a serving cell. In particular, D2D communication may be required between devices that are outside of network coverage for purposes such as public safety.

In order to perform D2D data transmission and reception via D2D communication, relevant control information must be transmitted and received between devices. The relevant control information may be referred to as a Scheduling Assignment (SA). The Rx terminal may perform a configuration for receiving D2D data based on the SA. The SA may include, for example, at least one of a New Data indicator (NDI), a Transmit UE Identification (Tx terminal ID), a Redundancy Version indicator (RV indicator), a Modulation and Coding Scheme Indication (MCS indication), a Resource Allocation (RA) indication, and a power control indication.

Here, the NDI indicates whether the current transmission is a repetition of the data, i.e., a retransmission, or something new. The receiver may combine the same data based on the NDI. The Tx Terminal ID indicates the ID of the transmitting terminal. The RV directive indicates the redundancy version by specifying different starting points in the circular buffer for reading the encoded buffer. Based on the RV indicator, the transmitting terminal can choose between different redundancy versions for iterations of the same packet. The MCS directive specifies the MCS level for D2D communication. Resource allocation indicates to which time/frequency physical resource the D2D data is allocated and transmitted. The power control instruction shall be a command for the terminal receiving the information to control the appropriate amount of power for the D2D transmission.

For a terminal supporting D2D communication, the radio resource for D2D communication may be the uplink channel of the (cellular) wireless communication system. In this case, the SA and data for D2D communication may be transmitted based on the PUSCH structure of the uplink physical channel of the wireless communication system, i.e., the PUSCH structure may be reused for the physical channel for D2D communication. For example, the physical channel for D2D communication may have a 24-bit Cyclic Redundancy Check (CRC) inserted, and turbo coding may be used. In addition, rate matching may be used for bit size matching and generating multiple transmissions. Scrambling may be used for interference randomization. PUSCH A demodulation reference signal (DMRS) may be used. The DMRS is used for channel estimation for coherent demodulation of the uplink received signal.

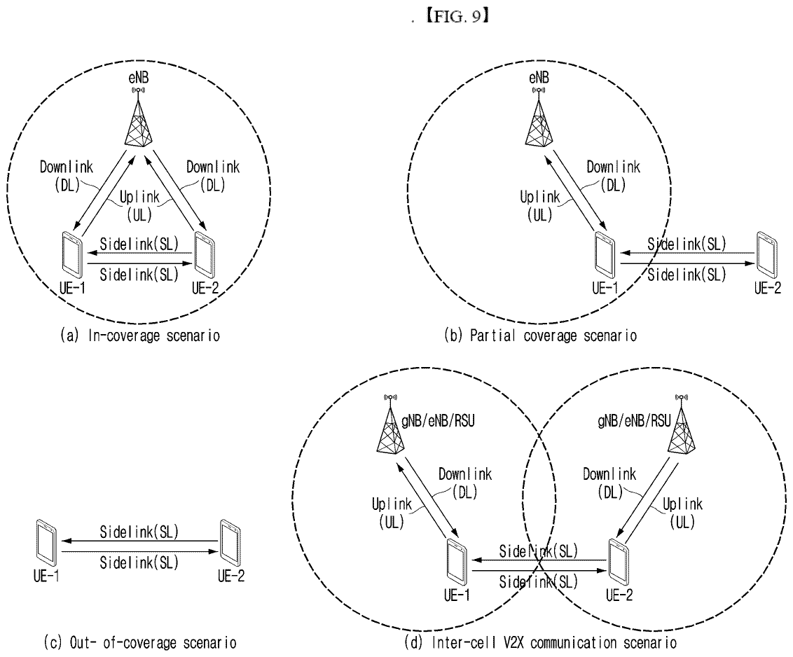

FIG. 9 is a diagram illustrating a system according to one embodiment of the present disclosure.

Referring to (a) of FIG. 9, all V2X terminals (UE-1, UE-2) are located within the coverage of the base station (gNB/eNB/RSU) (In-coverage scenario). All V2X terminals (UE-1, UE-2) can receive data and control information from the base station (gNB/eNB/RSU) via downlink (DL) or transmit data and control information to the base station via uplink (UL). The data and control information may be data and control information for V2X communication or data and control information for general cellular communication other than V2X communication. Also, in (a) of FIG. 9, the V2X terminals UE-1 and UE-2 may transmit and receive data and control information for V2X communication via a sidelink (SL).

Referring to (b) of FIG. 9, UE-1 of the V2X terminals is located within the coverage of the base station (gNB/eNB/RSU) and UE-2 is located outside the coverage of the base station (gNB/eNB/RSU) (partial coverage scenario). Referring to (b) of FIG. 9, the terminal UE-1 located within the coverage of the base station may receive data and control information from the base station via downlink (DL) or transmit data and control information to the base station via uplink (UL). Referring to (b) of FIG. 9, the terminal UE-2 located outside the coverage area of the base station cannot receive data and control information from the base station via downlink and cannot transmit data and control information to the base station via uplink. The terminal UE-2 can transmit and receive data and control information for V2X communication through the sidelink SL with the terminal UE-1.

FIG. 9 (c) shows a case where all V2X terminals (UE-1, UE2) are located outside the coverage area of the base station (gNB/eNB/RSU). Referring to (c) of FIG. 9, the terminals (UE-1, UE-2) cannot receive data and control information from the base station via downlink (DL), and cannot transmit data and control information to the base station via uplink (UL). On the other hand, the terminal UE-1 and the terminal UE-2 can transmit/receive data and control information for V2X communication through the sidelink SL.

FIG. 9 (d) illustrates a case where the V2X transmitting terminal and the V2X receiving terminal are connected to different base stations (gNB/eNB/RSU) (RRC connected state) or are camping (RRC disconnected state, i.e., RRC idle state) (inter-cell V2X communication). In this case, the UE-1 may be a V2X transmitting terminal and the UE-2 may be a V2X receiving terminal. Alternatively, the terminal UE-1 may be a V2X receiving terminal and the terminal UE-2 may be a V2X transmitting terminal. The UE-1 may receive a V2X-specific System Information Block (SIB) from the base station to which the UE-1 is connected (or where it is camped), and the UE-2 may receive a V2X-specific SIB from another base station to which the UE-2 is connected (or where it is camped). In this case, the information in the V2X-only SIB received by the UE-1 may be different from the information in the V2X-only SIB received by the UE-2. Therefore, in order to perform V2X communication between terminals located in different cells, it is necessary to unify the received SIB information.

In FIG. 9, a V2X system comprising two terminals (UE-1, UE-2) is illustrated as an example for ease of explanation, but without limitation, various numbers of terminals may participate in the V2X system. Furthermore, the uplink (UL) and downlink (DL) between the base station (eNB/gNB/RSU) and the V2X terminals (UE-1, UE2-) may be named as Uu interfaces, and the sidelink (SL) between the V2X terminals (UE-1, UE-2) may be named as PC5 interfaces. Therefore, they may be used interchangeably in the present disclosure.

In the present disclosure, a terminal may refer to a vehicle supporting vehicle-to-vehicle (V2V) communication, a vehicle supporting vehicle-to-pedestrian (V2P) communication, a handset (e.g., smartphone) of a vehicle or pedestrian supporting vehicle-to-pedestrian (V2P) communication, a vehicle supporting vehicle-to-network (V2N) communication, or a vehicle supporting vehicle-to-infrastructure (V2I) communication. As used herein, a terminal may also refer to a roadside unit (RSU) equipped with terminal functionality, an RSU equipped with base station functionality, or an RSU equipped with some of the base station functionality and some of the terminal functionality.

In the present disclosure, a sidelink control channel may be referred to as a physical sidelink control channel (PSCCH), and a sidelink shared channel or data channel may be referred to as a physical sidelink shared channel (PSSCH). In addition, the broadcast channel that is broadcast with the synchronization signal may be referred to as the physical sidelink broadcast channel (PSBCH), and the channel for feedback transmission may be referred to as the physical sidelink feedback channel (PSFCH). However, either PSCCH or PSSCH may be used for feedback transmission. Depending on the communication system, it may be referred to as LTE-PSCCH, LTE-PSSCH, NR-PSCCH, NR-PSSCH, etc. In the present disclosure, a sidelink may refer to a link between terminals and a Uu link may refer to a link between a base station and a terminal.

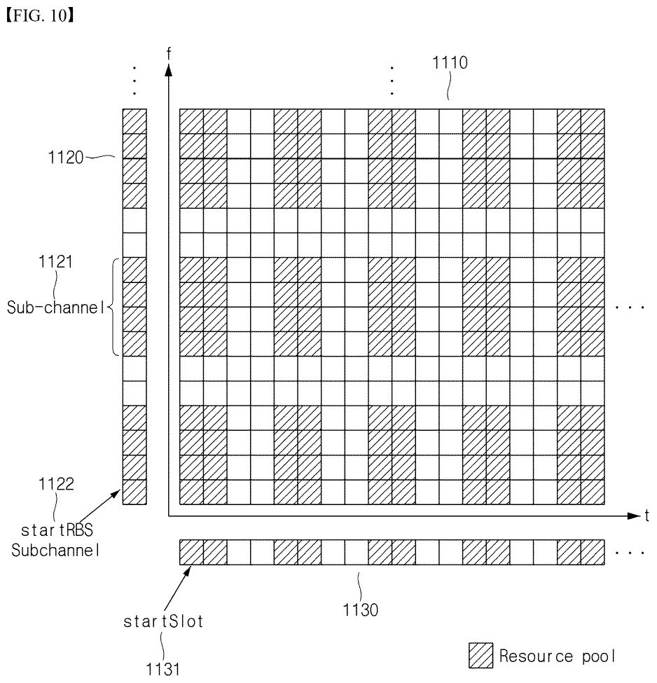

FIG. 10 is a diagram for illustrating a resource pool, defined as a set of resource resources in time and frequency used for transmitting and receiving sidelinks according to one embodiment of the present disclosure.

Referring now to 1110 of FIG. 10, a case where a resource pool is allocated discontinuously over time and frequency is illustrated. While the present disclosure focuses on the case where the resource pool is allocated discontinuously in frequency, it is understood that the resource pool may be allocated continuously in frequency.

Referring to 1120 of FIG. 10, a discontinuous resource allocation over frequency may be accomplished. The granularity of the resource allocation over frequency may be a physical resource block (PRB).

Further, referring to 1121 of FIG. 10, the resource allocation over frequency may be based on a sub-channel. A sub-channel may be defined as a unit of resource allocation on a frequency comprising a plurality of RBs. Specifically, a sub-channel may be defined as an integer multiple of RBs. Referring to 1121 of FIG. 10, a case is illustrated where a subchannel is sized to consist of four contiguous PRBs. Subchannels may be sized differently, and while it is common for a subchannel to be composed of consecutive PRBs, it is not required that a subchannel be composed of consecutive PRBs. A subchannel may be the basic unit of resource allocation for a Physical Sidelink Shared Channel (PSSCH) or Physical Sidelink Control Channel (PSCCH), and the size of the subchannel may be set differently depending on whether the channel is a PSSCH or PSCCH. Note also that a subchannel may be referred to as a Resource Block Group (RBG). The following describes methods for allocating a non-contiguous resource pool over a frequency and dividing the allocated resource pool into a plurality of subchannels.

Referring to 1122 of FIG. 10, startRBSubchanel may indicate a starting position of a subchannel on a frequency in the resource pool.

A resource block, which is a frequency resource belonging to a resource pool for PSSCH in an LTE V2X system, may be determined in a manner as shown in Table 5 below.

```
TABLE 5
- The resource block pool consists of N_{subCH} sub-channels where N_{subCH}
  is given by higher layer parameter numSubchannel.
- The sub-channel m for m = 0,1,...,N_{subCH} − 1 consists of a set of
  n_{subCHsize} contiguous resource blocks with the physical resource block
  number n_{PRB} = n_{subCHRBstart} + m * n_{subCHsize} + j for j = 0, 1,...,
  n_{subCHsize} − 1
  where n_{subCHRBstart} and n_{subCHsize} are given by higher layer parameters
  startRBSubchannel and sizeSubchannel, respectively
```

1130 of FIG. 10 illustrates a case where the resource allocation is discontinuous in time. The granularity of the temporal resource allocation may be a slot. While the present disclosure focuses on the case where the resource pool is allocated discontinuously in time, it is of course possible for the resource pool to be allocated continuously in time.

Referring to 1131 of FIG. 10, startSlot may indicate a starting position of a slot in the resource pool in time.

A subframe, which is a temporal resource belonging to a resource pool for PSSCH in an LTE V2X system, may be determined in a manner as shown in Table 6 below.

```
TABLE 6
$θ \leq \text{?} < 102240.$
the subframe index is relative to subframe [symbol]   of the radio frame corresponding to SFN 0 of the serving
cell or DFN 0 (described in [11]),
the set includes all the subframes except the following subframes,
  subframes in which SLSS resource is configured.
  downlink subframes and special subframes if the sidelink transmission occurs in a [symbol]  DD cell,
  reserved subframes which are determined by the following steps:
    1) the remaining subframes excluding N [symbol]   and N [symbol]   subframes from the set of all the
      subframes are denoted by ( [symbol]  ) arranged in increasing order of subframe
      index, where N [symbol]   is the number of subframes in which SLSS resource is configured within
      10240 subframes and N [symbol]   is the number of downlink subframes and special subframes within
      10240 subframes if the sidelink transmission occurs in a TDD cell.
    2) a subframe [symbol]   (0 ≤ r < (10240 − N [symbol]   − N [symbol]   )) belongs to the reserved subframes if
      $\text{?}$
      N [symbol]    = (10240 − N [symbol]   − N [symbol]   )mod L [symbol]   . Here, [symbol]    the length of the bitmap is
      configured by higher layers.
the subframes are arranged in increasing order of subframe index.
A bitmap (b₀, b₁, . . . , b [symbol]   ) associated the the resource pool is used where L [symbol]    the length of
the bitmap is configured by higher layers.
$\text{?}$
  b [symbol]   = 1 where k′ = k mod  L [symbol] . [symbol]
indicates data missing or illegible when filed
```

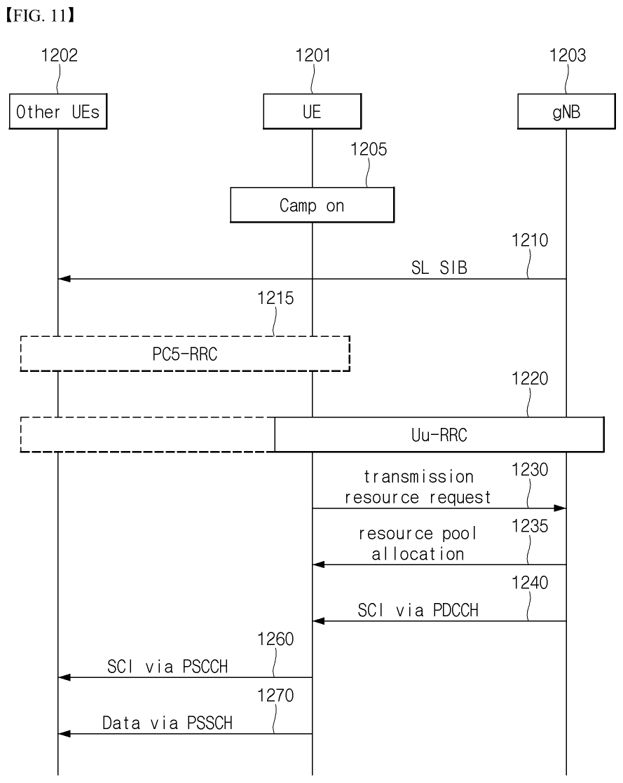

FIG. 11 is a flow diagram to illustrate a scheduled resource allocation (mode 1) method in a sidelink according to one embodiment of the present disclosure.

The scheduled resource allocation (mode 1) method is a method in which a base station allocates resources used for sidelink transmission to RRC-connected terminals in a dedicated scheduling manner. The Scheduled resource allocation (mode 1) method is effective for interference management and resource pool management because the base station can manage the resources of the sidelink.

Referring to FIG. 11, the terminal 1201 that is camping on 1205 may receive SL SIB (Sidelink System Information Bit) 1210 from the base station 1203. The system information may include resource pool information for transmission and reception, setting information for sensing behavior, information for setting motivation, information for inter-frequency transmission and reception, and the like. Once the terminal 1201 has generated data traffic for V2X, it can perform an RRC connection with the base station 1220. The RRC connection between the terminal and the base station may be referred to as Uu-RRC 1220. The Uu-RRC connection may be performed prior to the generation of data traffic for V2X. The terminal 1201 may request transmission resources from the base station 1203 to enable V2X communication with other terminals 1202 1230. At this time, the terminal 1201 may request transmission resources from the base station 1203 to enable V2X communication using RRC messages or MAC CEs (1230). Here, the RRC message may be a SidelinkUEInformation, UEAssistanceInformation message. The MAC CE may be a buffer status report MAC CE in a new format, such as a buffer status report MAC CE that includes at least an indicator that it is a buffer status report for V2X communication and information about the size of the data buffered for D2D communication. The detailed format and content of the buffer status report used by 3GPP can be found in 3GPP standard TS36.321 E-UTRA MAC Protocol Specification. The base station 1203 may allocate V2X transmission resources to the terminal 1201 via a dedicated Uu-RRC message. The dedicated Uu-RRC message may be included in the RRCConnectionReconfiguration message. The resources allocated may be V2X resources over Uu or resources for PC5, depending on the type of traffic requested by the terminal 1201 or whether the link is congested. For resource allocation decisions, the terminal may additionally send the ProSe Per Packet Priority (PPPP) or Logical Channel ID (LCID) information of the V2X traffic via UEAssistanceInformation or MAC CE. Since the base station 1203 also has information about the resources utilized by the other terminals 1202, it can allocate the remaining pool of resources requested by the terminal 1201 (12-35). The base station 1203 may instruct the terminal 1201 for final scheduling with a DCI transmission over PDCCH (1240).

In the case of broadcast transmission, the terminal 1201 may broadcast SCI (Sidelink Control Information) to other terminals 1202 over PSCCH as a broadcast without establishing an RRC for additional sidelinks 1270, and may also broadcast data to other terminals 12-02 over PSSCH 1270.

In contrast, in the case of unicast and groupcast transmissions, the terminal 1201 may perform RRC connections with other terminals 1202 on a one-to-one basis. Here, the terminal-to-terminal RRC connection may be named PC5-RRC to distinguish it from Uu-RRC. Even in the case of a groupcast, the PC5-RRC 1215 may be individually connected between terminals and terminals in the group. In FIG. 11, the association of the PC5-RRC 1215 is shown as an operation after the transmission 1210 of the SL SIB, but it can be performed at any time before the transmission 1210 of the SL SIB or before the transmission 1260 of the SCI. If an RRC connection is required between the terminal and the sidelink, the sidelink's PC5-RRC connection (1215) may be established and the Sidelink Control Information (SCI) may be transmitted unicast or groupcast to other terminals (1202) via PSCCH (1260). In this case, a groupcast transmission of SCI may be interpreted as a group SCI. Additionally, data may be transmitted unicast or groupcast to other terminals 1202 via PSSCH (1270).

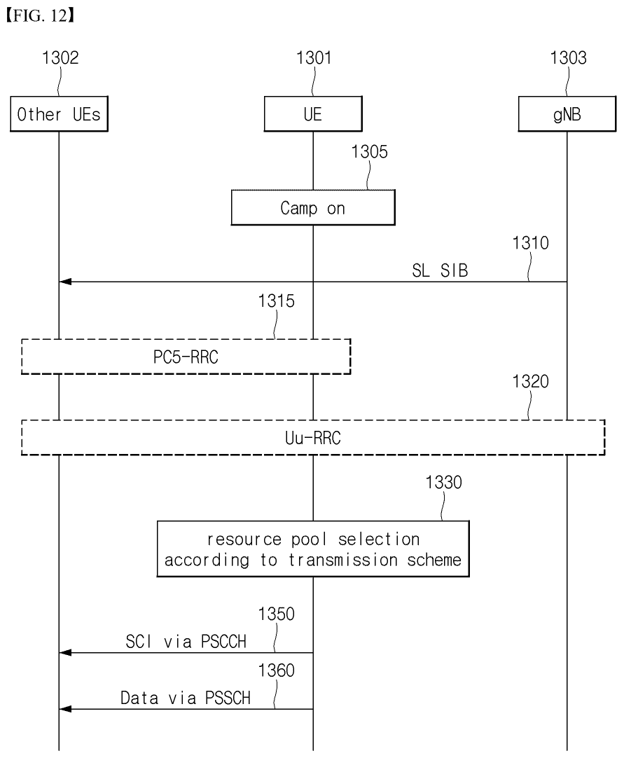

FIG. 12 is a flow diagram to illustrate a UE autonomous resource allocation (mode 2) method in a sidelink according to one embodiment of the present disclosure.

In the UE autonomous resource allocation (mode 2) method, the base station 1303 provides a pool of sidelink transmission and reception resources for V2X as system information, and the terminal 1301 may select a transmission resource according to a predetermined rule. The resource selection method may include zone mapping, sensing-based resource selection, random selection, etc. In contrast to the scheduled resource allocation (mode 1) method, where the base station 1303 is directly involved in resource allocation, FIG. 12 differs from the scheduled resource allocation (mode 1) method in that the terminal 1301 autonomously selects resources and transmits data based on a pool of resources received in advance via system information. In V2X communication, the base station 1303 may allocate different types of resource pools (V2V resource pool, V2P resource pool) for the terminal 1301. The allocatable resource pools may comprise resource pools in which the terminal 1301 can autonomously select an available resource pool after sensing the resources used by other nearby terminals 1302, and resource pools in which the terminal 1301 randomly selects resources from a preset resource pool.

The terminal 1301 that is camping on 1305 may receive 1310 a Sidelink System Information Bit (SL SIB) from the base station 1303. The system information may include resource pool information for transmitting and receiving, setting information for sensing behavior, information for setting motivation, information for inter-frequency transmitting and receiving, and the like. A difference in operation between FIG. 11 and FIG. 12 is that in FIG. 11, the base station 1203 and the terminal 1301 operate in an RRC-connected state, whereas in FIG. 12, the base station 1203 and the terminal 1301 may also operate in an RRC-unconnected idle mode 1320. Further, in the RRC-unconnected idle mode 1320, the base station 1303 may operate to allow the terminal 1301 to autonomously select transmission resources without directly engaging in resource allocation. When the terminal 1301 generates data traffic for V2X, the terminal 1301 may select a resource pool in the time/frequency domain from among the resource pools communicated via system information from the base station 1303, according to a set transmission behavior.

Next, in the case of a broadcast transmission, the terminal 1301 may broadcast SCI (Sidelink Control Information) to the other terminals 1302 via PSCCH as a broadcast without setting the RRC of an additional sidelink (1350). In addition, the terminal 1301 may broadcast data to the other terminals 1302 via PSSCH (1360).

In contrast, for unicast and groupcast transmissions, the terminal 1301 may perform RRC connections with other terminals 1302 on a one-to-one basis. Here, terminal to terminal RRC connections may be referred to as PC5-RRC, as distinguished from Uu-RRC. Even in the case of a groupcast, PC5-RRCs may be individually established between terminals in a group and terminals in the group. This can be analogized to the RRC layer connections in the connections between the base station and the terminal in NR uplinks and downlinks, and the connections at the RRC layer level in sidelinks can be called PC5-RRC. The PC5-RRC connection may be used to exchange UE capability information between terminals for the sidelink, or to exchange configuration information required to transmit and receive signaling. In FIG. 12, the connection of the PC5-RRC 1315 is shown as an operation after the SL SIB transmission 13-10, but it may be performed at any time before the SL SIB transmission 13-10 or before the SCI transmission 13-50. If an RRC connection is required between the terminals, the PC5-RRC connection of the sidelink can be performed (1315) and Sidelink Control Information (SCI) can be sent unicast or groupcast to other terminals (1302) via PSCCH (1350). In this case, a groupcast transmission of SCI may be interpreted as a group SCI. In addition, data may be transmitted unicast and groupcast to other terminals 1302 via PSSCH (1360).

In the present disclosure, a transmitting terminal (TX UE) may be a terminal that transmits data to a (target) receiving terminal (RX UE). For example, the TX UE may be a terminal that performs PSCCH and/or PSSCH transmissions, and/or the TX UE may be a terminal that transmits SL CSI-RS and/or SL CSI report request indicator to the (target) RX UE. And/or, the TX UE may be a terminal that transmits a (control) channel (e.g., PSCCH, PSSCH, etc.) and/or a reference signal (e.g., DM-RS, CSI-RS, etc.) on the (control) channel to be used for SL RLM and/or SL RLF operation of the (target) RX UE.

Furthermore, in the present disclosure, the receiving terminal (RX UE) may be a terminal that transmits SL HARQ feedback to the TX UE based on (i) the success of decoding the data received from the transmitting terminal (TX UE) and/or (ii) the success of detecting/decoding the PSCCH transmitted by the TX UE (related to PSSCH scheduling). and/or the RX UE may be the terminal that performs the SL CSI transmission to the TX UE based on the SL CSI-RS and/or SL CSI report request indicator received from the TX UE. and/or the RX UE may be the terminal that transmits the measured SL (L1) RSRP measurement value to the TX UE based on the (predefined) reference signal received from the TX UE and/or the SL (L1) RSRP report request indicator, and/or the RX UE may be a terminal that transmits the RX UE's own data to the TX UE. and/or, the RX UE may be a terminal that performs SL RLM and/or SL RLF operations based on a (preset) (control) channel received from the TX UE and/or a reference signal on the (control) channel.

In the present disclosure, for example, when the RX UE transmits SL HARQ feedback information for PSSCHs and/or PSCCHs received from the TX UE, the method below or some of the methods below may be contemplated. Here, for example, the method below or some of the methods below may be applied restrictively only when the RX UE has successfully decoded/detected the PSCCH that schedules the PSSCH.

Option 1) The NACK information may be sent to the TX UE only if the RX UE fails to decode/receive the PSSCH received from the TX UE.

Option 2) If the RX UE succeeds in decoding/receiving the PSSCH received from the TX UE, it may transmit ACK information to the TX UE, and if it fails to decode/receive the PSSCH, it may transmit NACK information to the TX UE.

In some embodiments of the present disclosure, for example, the TX UE may transmit the following information or some of the following information to the RX UE via SCI. Here, for example, the TX UE may transmit some or all of the below information to the RX UE via a first SCI (FIRST SCI) and/or a second SCI (SECOND SCI).
PSSCH (and/or PSCCH) related resource allocation information (e.g., time/frequency resource location/number, resource reservation information (e.g., period))
SL CSI Report Request Indicator or SL (L1) RSRP (and/or SL (L1) RSRQ and/or SL (L1) RSSI) Report Request Indicator
SL CSI transmission indicator (on PSSCH) (or SL (L1) RSRP (and/or SL (L1) RSRQ and/or SL (L1) RSSI) information transmission indicator)
MCS information
TX POWER information
L1 DESTINATION ID information and/or L1 SOURCE ID information
SL HARQ PROCESS ID information
NDI information
RV information
QoS information (related to the transmitted TRAFFIC/PACKET) (e.g., PRIORITY information)
SL CSI-RS transmit indicator or number of SL CSI-RS antenna ports (transmitted) information
TX UE location information or location (or distance area) information of the target RX UE (for which SL HARQ feedback is requested)

Reference signal (e.g., DM-RS, etc.) information relevant to the decoding (and/or channel estimation) of data transmitted over PSSCH. For example, it may be information related to the pattern of the (time-frequency) mapping resources of the DM-RS, RANK information, antenna port index information, etc.

Further, in the present disclosure, the TX UE may transmit the SCI, the first SCI (FIRST SCI), and/or the second SCI (SECOND SCI) to the RX UE via the PSCCH, such that the PSCCH may be replaced/substituted with (i) the SCI and/or (ii) the FIRST SCI and/or (iii) the SECOND SCI. and/or SCI may be replaced/substituted by PSCCH and/or FIRST SCI and/or SECOND SCI. And/or, since the TX UE may transmit the SECOND SCI to the RX UE via PSSCH, the PSSCH may be replaced/replaced with the SECOND SCI.

In the present disclosure, for example, where the SCI configuration fields are divided into two groups in consideration of the (relatively) high SCI payload size, the first SCI comprising the first group of SCI configuration fields may be referred to as the FIRST SCI, and the second SCI comprising the second group of SCI configuration fields may be referred to as the SECOND SCI. Further, for example, the FIRST SCI may be transmitted to the receiving terminal via PSCCH. Furthermore, for example, the SECOND SCI may be transmitted to the receiving terminal via an (independent) PSCCH or piggybacked with data via PSSCH.

As used herein, for example, “setting” or “defining” may refer to a (resource pool specific) (PRE) CONFIGURATION from a base station or network (via predefined signaling (e.g., SIB, MAC, RRC, etc.)).

In some aspects of the present disclosure, for example, RLF may be determined based on an OUT-OF-SYNCH (OOS) indicator or an IN-SYNCH (IS) indicator, and thus may be replaced/substituted with OUT-OF-SYNCH (OOS) or IN-SYNCH (IS).

In the present disclosure, for example, RB may be replaced/substituted with SUBCARRIER. Also, in the present disclosure, for example, PACKET or TRAFFIC may be replaced by TB or MAC PDU, depending on the layer at which it is transmitted.

In one aspect of the disclosure, CBG or CG may be substituted/replaced with TB.

In the present disclosure, for example, the SOURCE ID may be replaced/replaced by the DESTINATION ID.

In the present disclosure, for example, an L1 ID may be replaced/substituted with an L2 ID. For example, the L1 ID may be an L1 SOURCE ID or an L1 DESTINATION ID. For example, the L2 ID may be an L2 SOURCE ID or an L2 DESTINATION ID.

In the following, a method for transmitting sidelink information proposed in the present disclosure will be described in detail.

Cooperative Intelligent Transport Systems (C-ITS) defines a structure that aims to improve the efficiency and safety of automated driving by exchanging user information between various user equipment (UE). C-V2X can be defined as the communication between vehicles and various devices, including vehicle-to-vehicle (V2V), vehicle-to-pedestrian (V2P), vehicle-to-infrastructure (V2I), and vehicle-to-network (V2N). Services required for LTE-V2X can include basic safety applications such as cooperative awareness messages (CAM), which can periodically broadcast basic information about the user such as speed, acceleration, destination, and other basic user information.

Cooperative awareness in road traffic means that road users and roadside infrastructure exchange information about each other's location, dynamics, and attributes. CAM is the information that is periodically exchanged between various UEs for cooperative awareness. With the evolution of 5G NR, V2X will evolve from LTE to 5GNR to include new capabilities that can support advanced V2X applications including swarm driving, advanced driving, and remote driving. These applications rely on the exchange of periodic messages and aperiodic messages, such as distributed environmental notification messages (DENMs), which are generated aperiodically to warn other users of dangerous road events, and can also be referred to as event-triggered messages. The reason for these messages may be due to special circumstances such as emergency brakes, accidents, ambulances, and other emergencies. Typically, these two types of messages (CAMs and DENMs) use the same resource pool (RP), which is good for uniform resource management and allocation, but can be disadvantageous for ensuring successful receipt of data packets, especially aperiodic data.

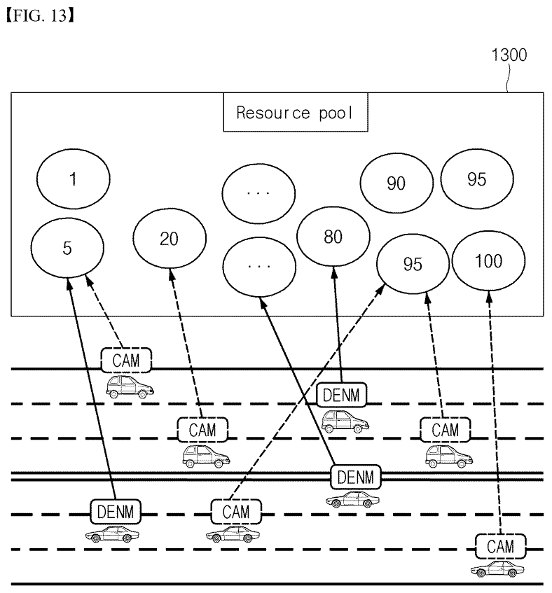

FIG. 13 is a diagram illustrating an example of how a resource pool may be set up for sidelink transfers. More specifically, FIG. 13 illustrates an example of a resource pool set up so that periodic CAM and aperiodic DENM share the same resource pool. Referring to FIG. 13, it can be seen that resources in the same resource pool 1310 are shared for periodic CAM and aperiodic DENM transmissions. Aperiodic messages may include more security-related messages that may be considered more sensitive than basic user information. Given that CAM and DENM are prioritized equally, the existing resource allocation method does not provide any benefit for DENM delivery, and the sudden occurrence of aperiodic messages can cause problems that affect the selection of periodic resources.

In the existing resource pool configuration, periodic CAM and aperiodic DENM are set to share the same resource pool. Since aperiodic messages (DENMs) contain more important security-related messages than basic user information, they require a higher reception success rate, but in the existing method, CAM and DENMs are set to the same priority, so the requirements of prioritized urgent DENMs are not met, and the aperiodic nature of DENMs inevitably affects the use of resources for sending other messages besides DENMs.

To address the above problems, the present disclosure proposes a method that can support a vehicle (terminal) to select resources from different resource pools depending on the type of message. More specifically, the proposed method proposes a method for dividing a resource pool into at least two or more resource pool portions based on the type of message transmitted by the terminal. The proposed method of setting up a resource pool has the effect of allowing a user to select an appropriate resource for sending a message based on the message type.

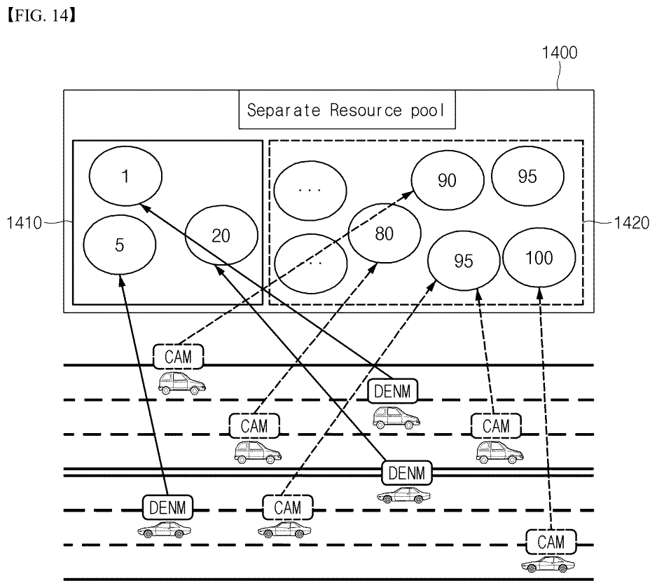

FIG. 14 is a diagram illustrating one example of a resource pool configuration proposed in the present disclosure. More specifically, FIG. 14 illustrates a case where DENM and CAM are transmitted over a sidelink. Referring to FIG. 14, the configured resource pool 1400 may include a resource pool portion 1410 for DENM transmissions and a resource pool portion 1420 for CAM transmissions, based on the type of message being transmitted over the sidelink. While FIG. 14 illustrates a case where DENM and CAM are transmitted, the resource pool may include at least two or more resource pool portions if other types of messages other than DENM and CAM are transmitted. Also, in FIG. 14, the resources included in the resource pool portion 1410 for DENM transmissions and the resource pool portion 1420 for CAM transmissions may each be indexed by an identifier.

The following describes in detail the operation of sidelink transmission on a resource pool that is divided into at least two or more resource pool parts based on message types. For the sake of simplicity, the following description focuses on the case where two types of side link information are transmitted in the resource pool, DENM and CAM, but it can be extended and applied to the case where other types of messages other than DENM and CAM are transmitted.

Step 1: The terminal generates DENM message. In this step, the terminal obtains information about the number of at least one terminal participating in the sidelink communication and information about the resources/resource pool. More specifically, the terminal may obtain the information about the resource/resource pool by receiving configuration information relating to the setting of a resource pool comprising resources for transmitting the sidelink information. The configuration information may further include information about the number of at least one terminal participating in the sidelink communication. In this case, the number of terminals (users) generating the DENM may be determined based on the following equation 1. In Equation 1 below, P_{DENM} represents a ratio value of the number of terminals performing side link transmissions among all terminals associated with a given resource pool divided by the number of at least one terminal associated with the resource pool. Based on P_{DENM}, the total number of sidelink transmissions sent on the resource pool may be determined, wherein P_{DENM} may be set to a value between 1% and 10%. Here, a terminal associated with a given resource pool may be interpreted to include a terminal that performs sidelink transmissions on the given resource pool at a particular point in time, and a terminal that does not perform sidelink transfers on the given resource pool at the particular point in time but could potentially perform sidelink transmissions on the resource pool.

$$Number of users send DENM = {P}_{DENM} * {N}_{all \_ vehicles} \qquad [ Equation 1 ]$$

$${P}_{DENM} ∈ [ 1 \% , 10 \% ]$$

Step 2: In this step, the configured resource pool is divided into two resource pool parts. More specifically, the entire resource pool may be configured to include two resource pool parts, RPₚₐᵣₜ₁ and RPₚₐᵣₜ₂ In this case, RPₚₐᵣₜ₁ may be used for DENM transmissions and RPₚₐᵣₜ₂ may be used for CAM transmissions. The number of resources included in the two resource pool portions RPₚₐᵣₜ₁ and RPₚₐᵣₜ₂ in the resource pool may be determined according to Equations 2 and 3 below, respectively.

$${N}_{\cdot {RP}_{part 1}} = {P}_{DENM} * {N}_{all \_ vehicles} + 2 \qquad [ Equation 2 ]$$

$${N}_{\cdot {RP}_{part 2}} = {N}_{all \_ resources} - {N}_{\cdot {RP}_{part 1}} \qquad [ Equation 3 ]$$

Step 3: In this step, the terminal selects a new Sensing Based Semi-Persistent Scheduling Select (SB-SPS) resource. First, the terminal selects resources according to the SB-SPS mechanism and determines the type of message (DENM or CAM) for which resource selection is required. Based on the message type, the terminal determines whether the resource for the message transmission is selected from the correct resource pool, i.e., if the message type determined by the terminal is DENM and the terminal selects a resource for DENM transmission, the terminal determines whether the resource selected for the DENM transmission is a resource included in the part of the resource pool related to DENM transmission. RPₚₐᵣₜ₁ If the type of message being sent by the terminal is a DENM and the selected resource is determined to be a resource contained in RPₚₐᵣₜ₁, the terminal may continue sending the message. In the opposite case, the terminal may continue to reselect resources until it determines that the selected resource is a resource contained in RPₚₐᵣₜ₁ If the type of message being sent by the device is a CAM, the device can continue sending the message if it determines that the selected resource is a resource included in RPₚₐᵣₜ₂ When all three steps described above have been completed, the device (user) will be able to use the appropriate resource for data transmission.

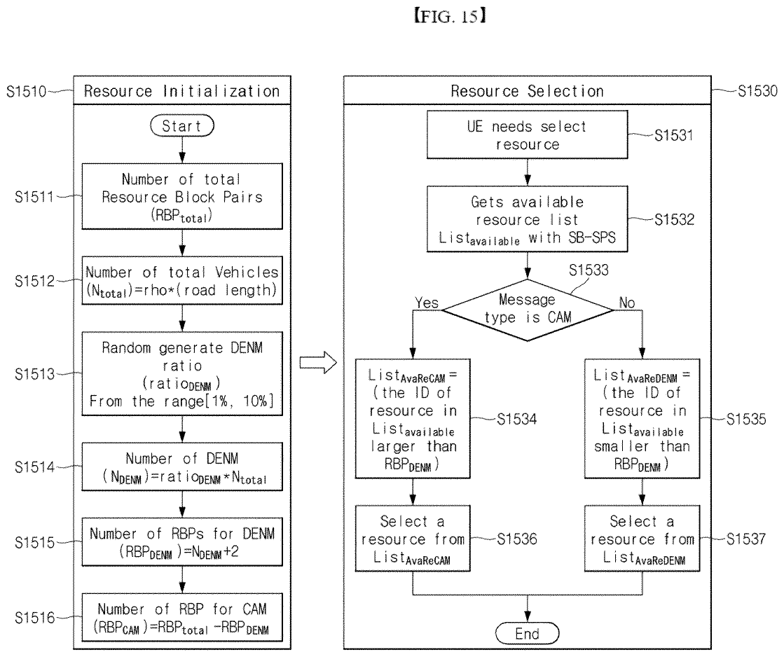

FIG. 15 is a diagram illustrating one example of a resource initialization and resource selection operation of a terminal according to the method proposed in the present disclosure.

In the resource initialization (S1510) operation of FIG. 15, the total resource block pair, and the total number of terminals (vehicles) involved in sidelink transmission is configured to the terminal (S1511, S1512). The total resource block pair, the total number of terminals (vehicles) involved in the sidelink transmission may be configured via configuration information via upper layer signaling. Thereafter, the terminal randomly generates a DENM ratio (S1513). In this case, the DENM ratio may be generated in a range from 1% to 10%. The terminal then determines the total number of DENMs to be transmitted from the resource pool (S1514). Based on the determined number of DENMs, the terminal then determines the portion of the resource pool associated with the DENM transmissions and the number of resources included in the portion of the resource pool (S1515). Next, the terminal determines a resource pool portion associated with the CAM transmission and a number of resources included in the resource pool portion associated with the CAM transmission based on the determined resource pool portion associated with the DENM transmission and the number of resource included in the resource pool portion associated with the DENM transmission (S1516).

In the case of the resource selection (S1530) operation of FIG. 15, the terminal may need to select a resource (S1531), and the terminal obtains a list of available resources (S1532). The list of available resources may be configured via configuration information via higher layer signaling. The terminal determines whether the message type is a CAM (S1533). If the message type is CAM, the terminal generates a list of resources available for CAM transmission (S1534) comprising resources in the list of available resources obtained in step S1532 that are larger than the resource block pair for DENM transmission, and the terminal selects a resource for CAM transmission from the list of resources available for CAM transmission (S1536). Conversely, if the message type is DENM, the terminal generates a list of resources available for DENM transmission that includes resources in the list of available resources obtained in step S1532 that are smaller than the resource block pair for DENM transmission (S1535), and the terminal selects a resource for DENM transmission from the list of resources available for DENM transmission (S1537).

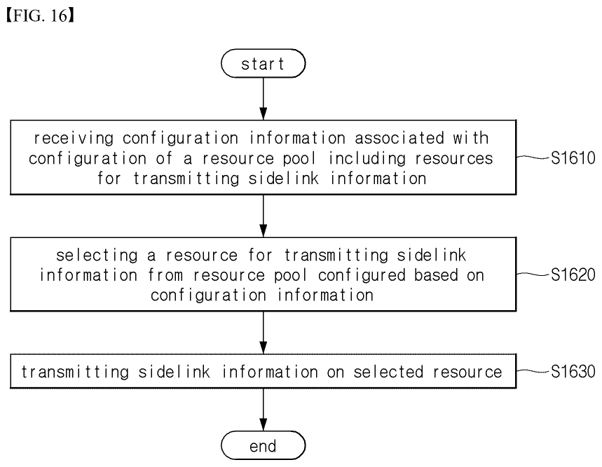

FIG. 16 is a flow diagram illustrating an example of how a method for transmitting sidelink information proposed in the present disclosure is performed on a terminal.

First, the terminal receives configuration information associated with configuration of a resource pool including resources for transmitting the sidelink information (S1610).

In this case, the resource pool is configured to be separated into at least two resource pool portions distinguished based on a type of transmitted information.

Afterwards, the terminal selects a resource for transmitting the sidelink information from the resource pool configured based on the configuration information (S1620).

Wherein, the selected resource for transmitting the sidelink information is a resource included in a specific resource pool portion which is associated with a type of the sidelink information among the at least two resource pool portions.

Lastly, the terminal transmits the sidelink information on the selected resource (S1630).

The terminal further comprises one or more transceivers, one or more processors, and one or more memories associated with the one or more processors storing instructions for operations to be executed by the one or more processors, and performing the operations described in FIG. 16.

Further, in an apparatus comprising one or more memories and one or more processors functionally coupled to the one or more memories, the one or more processors control the apparatus to perform the operations described in FIG. 16.

Further, in one or more non-transitory computer-readable media storing one or more instructions, the one or more instructions executable by the one or more processors control the device to perform the actions described in FIG. 16.

Various embodiments of the present disclosure may be combined with each other.

Without limitation, the various descriptions, features, procedures, suggestions, methods, and/or flowcharts of operations disclosed herein may be applied to various fields requiring wireless communication/connectivity (e.g., 5G) between devices.

The operations described herein may be realized by providing any component of the UE or eNB with a memory device storing corresponding program code, i.e., the control unit of the UE or eNB may execute the operations described herein by reading and executing the program code stored in the memory device by a processor or central processing unit (CPU).

The various components, modules, etc. of a UE or eNB described herein may be operated using hardware circuits, such as logic circuits based on complementary metal oxide semiconductors, firmware, software, and/or a combination of hardware and firmware and/or software embedded in a machine-readable medium. For example, various electrical structures and methods may be implemented using electrical circuits such as transistors, logic gates, and custom semiconductors.

While specific embodiments have been described in the detailed description of the present disclosure, various modifications are of course possible without departing from the scope of the disclosure. Therefore, the scope of the present disclosure should not be limited to the described embodiments, but should be defined by the scope of the following patent claims, as well as by things coextensive with the scope of these claims.

1. A method of a terminal for transmitting sidelink information in a wireless communication system, receiving configuration information associated with configuration of a resource pool including resources for transmitting the sidelink information,
wherein the resource pool is configured to be separated into at least two resource pool portions distinguished based on a type of transmitted information;
selecting a resource for transmitting the sidelink information from the resource pool configured based on the configuration information,
wherein the selected resource for transmitting the sidelink information is a resource included in a specific resource pool portion which is associated with a type of the sidelink information among the at least two resource pool portions; and
transmitting the sidelink information on the selected resource.

2. The method of claim 1, further comprising:
receiving information on a number of at least one terminal associated with the resource pool.

3. The method of claim 2, further comprising:
generating the sidelink information,
wherein a number of total sidelink information transmitted on the resource pool is determined based on a ratio value dividing a number of terminal performing sidelink transmission among the at least one terminal associated with the resource pool by the number of the at least one terminal associated with the resource pool.

4. The method of claim 3,
wherein the ratio value is determined from values included in a pre-defined range.

5. The method of claim 1, wherein in case that a number of the at least two resource pool portions is 2, one resource pool portion is associated with sidelink information of a first type, and other resource pool portion is associated with sidelink information of a second type which is different from the first type.

6. The method of claim 5,
wherein the other resource pool portion associated with the sidelink information of the second type is configured to be a region excluding the one resource pool portion associated with the sidelink information of the first type from a whole resource region of the resource pool.

7. The method of claim 5,
wherein the sidelink information of the first type is DENM (decentralized environmental notification messages), and
wherein the sidelink information of the second type is CAM (cooperative awareness message).

8. The method of claim 1,
wherein resources included in each of the at least two resource pool portions are indexed by an identifier, respectively.

9. The method of claim 1, further comprising:
reselecting the resource for transmitting the sidelink information in case that the selected resource for transmitting the sidelink information is not a resource included in the specific resource pool portion associated with the type of the sidelink information.

10. The method of claim 9, wherein the reselecting the resource for transmitting the sidelink information is performed iteratively until the reselected resource for the sidelink information is determined to be a resource included in the specific resource pool portion associated with the type of the sidelink information.

11. A terminal for performing a sidelink transmission in a wireless communication system, the terminal comprising:
one or more transmitters and receivers;
one or more processors; and
one or more memories associated with the one or more processors, storing instructions for operations executed by the one or more processors,
wherein the operations comprise,
receiving configuration information associated with configuration of a resource pool including resources for transmitting the sidelink information,
wherein the resource pool is configured to be separated into at least two resource pool portions distinguished based on a type of transmitted information;
selecting a resource for transmitting the sidelink information from the resource pool configured based on the configuration information,
wherein the selected resource for transmitting the sidelink information is a resource included in a specific resource pool portion which is associated with a type of the sidelink information among the at least two resource pool portions; and
transmitting the sidelink information on the selected resource.

12. An apparatus comprising one or more memories and one or more processors functionally coupled to the one or more memories,
wherein the one or more processors controls the apparatus to:
receive configuration information associated with configuration of a resource pool including resources for transmitting the sidelink information,
wherein the resource pool is configured to be separated into at least two resource pool portions distinguished based on a type of transmitted information;
select a resource for transmitting the sidelink information from the resource pool configured based on the configuration information,
wherein the selected resource for transmitting the sidelink information is a resource included in a specific resource pool portion which is associated with a type of the sidelink information among the at least two resource pool portions; and
transmit the sidelink information on the selected resource.

13. (canceled)
